(19) United States
(12) Patent Application Publication
(10) Pub. No.: US 2023/0046270 A1
(43) Pub. Date: Feb. 16, 2023

(54) LINK PROCESSING METHOD, MULTI-LINK DEVICE, AND COMPUTER-READABLE STORAGE MEDIUM

(71) Applicant: HUAWEI TECHNOLOGIES CO., LTD., Shenzhen (CN)

(72) Inventors: Guogang HUANG, Shenzhen (CN); Ming GAN, Shenzhen (CN); Yifan ZHOU, Shenzhen (CN); Yuchen GUO, Shenzhen (CN); Yunbo LI, Shenzhen (CN)

(21) Appl. No.: 17/967,024

(22) Filed: Oct. 17, 2022

Related U.S. Application Data
(63) Continuation of application No. PCT/CN2021/087955, filed on Apr. 17, 2021.

(30) Foreign Application Priority Data
Apr. 18, 2020 (CN) 202010308652.7

(51) Int. Cl. H04W 76/15; H04W 76/27

(52) U.S. Cl. CPC H04W 76/15; H04W 76/27

(57) ABSTRACT

First information received by a first MLD on a first link is used to determine whether a BSS configuration of a second link is updated. In response to the BSS configuration of the second link not being updated, the first MLD directly transmits a data frame on the switched-to second link or the second link whose status is transited, and the data frame is not transmitted until a beacon frame is received and a latest parameter of the BSS configuration is obtained on the switched-to second link or the second link whose status is transited. A waiting time occurring before the data frame is transmitted is reduced.

### CROSS-REFERENCE TO RELATED APPLICATIONS

This application is a continuation of International Application No. PCT/CN2021/087955, filed on Apr. 17, 2021, which claims priority to Chinese Patent Application No. 202010308652.7, filed on Apr. 18, 2020. The disclosures of the aforementioned applications are herein incorporated by reference in their entireties.

### BACKGROUND

To achieve extremely high throughput, a next generation standard of a wireless local area network (Wireless Local Area Network, WLAN) uses a multi-link as a key technology. The multi-link is that each WLAN device has a multi-band transmit and receive capability, to improve throughput on a larger bandwidth. The multiband includes but is not limited to 2.4 GHz, 5 GHz, 6 GHz, and the like. Access and transmission on a plurality of frequency bands are referred to as a multi-link. In addition, a device that supports a plurality of links is referred to as a multi-link device.

The multi-link device includes a multi-radio multi-link device and a single-radio multi-link device. The multi-radio multi-link device has a plurality of radio frequency modules, and the radio frequency modules separately works on different frequency bands or channels. In response to a channel spacing between the radio frequency modules that separately work being large enough, links operate independently without mutual interference. The multi-radio multi-link device works in an energy-saving mode. A link without data transmission is enabled to be in a doze or disable state. A link with data transmission is enabled to be in an active or enable state. That is, the link needs to transit from a doze or disable state to an active or enable state. The single-radio multi-link device having a single radio frequency module works on different frequency bands or channels, but works only on one frequency band at any moment, that is, needs to switch from one link to another link.

For a link whose link status is transited or a switched-to link, to transmit a data frame, a beacon (beacon) frame further needs to be received on the link whose status is transited or the switched-to link, to obtain a latest BSS configuration used for data transmission on the link.

This process causes an excessively long waiting time in response to determining to transit the link status or switch to the link to a time the data frame is transmitted. In other words, fast transition between link statuses or fast switching between links cannot be implemented.

### SUMMARY

Embodiments described herein provide a link processing method, a multi-link device, and a computer-readable storage medium, to implement fast transition between link statuses or fast switching between links.

In at least one embodiment, a link processing method is provided. In the method, a plurality of links between a first MLD and a second MLD include a first link and a second link. The first MLD receives first information of the second link on the first link. The first information is used by the first MLD to determine whether a BSS configuration of the second link is updated. In response to the BSS configuration of the second link not being updated, the first MLD transmits a data frame on the switched-to second link or the second link whose status is transited, and does not need to transmit the data frame until a beacon frame is received and a latest parameter of the BSS configuration is obtained on the switched-to second link or the second link whose status is transited. Therefore, the method reduces a waiting time before the data frame is transmitted on the switched-to second link or the second link whose status is transited.

In addition, in response to a data frame on the first link being switched to the second link, in the method, before switching from the first link to the second link, the first MLD learns that the BSS configuration of the second link is not updated. In this way, the first MLD directly transmits the data frame on the switched-to second link, and does not need to transmit the data frame until a beacon frame is received and a latest BSS configuration is obtained after switching. Therefore, in the method, impact duration of a link switching process on data frame transmission is shortened. In response to a data frame on the first link being offloaded to the second link, in the method, before a status of the second link is transited, the first MLD learns that the BSS configuration of the second link is not updated, and directly transmits the data frame on the second link whose status is transited without waiting for a beacon frame to be received. Therefore, duration used for data frame offloading transmission is shortened.

The first link is a link in an enable state. The second link is a switched-to link or a link whose link status is transited.

Optionally, the data frame is an uplink data frame, a quality of service null (QoS NULL) frame, or a link status notification frame. The link status notification frame indicates that the second link is in an awake (awake) or enable (enable) state, so that the second MLD sends a downlink data frame on the second link in time. In addition, the uplink data frame and the quality of service null (QoS NULL) frame also notifies the second MLD that the second link is in the awake or enable state.

In at least one embodiment, in response to the BSS configuration of the second link being updated, the method further includes: The first MLD sends second information on the second link. The second information is a sequence number of the BSS configuration, an access point configuration sequence number (AP-CSN), or a check beacon (check beacon) value that is stored in the first MLD and that identifies the second link. The first MLD receives, on the second link, an updated parameter of the BSS configuration of the second link. The updated parameter of the BSS configuration of the second link is determined based on the second information.

Optionally, the second information of the second link is carried, for sending, in a unicast probe request frame on the second link. The updated parameter of the BSS configuration of the second link is carried in a probe response frame that is received on the second link. The probe response frame is returned based on the unicast probe request frame. That is, in response to the BSS configuration of the second link being updated, the first MLD obtains the updated parameter of the BSS configuration of the second link through the unicast probe request frame and the probe response frame on the second link. The unicast probe request frame carries the second information. The second information is used by the second MLD to determine a parameter that needs to be updated in the BSS configuration. In at least one embodiment, the first MLD sends the unicast probe request frame on the second link. The unicast probe request frame includes the second information. The first MLD receives, on the second link, the updated parameter of the BSS configuration of the second link. The updated parameter of the BSS configuration of the second link is obtained by the second MLD by comparing the second information with the first information.

In at least one embodiment, although the BSS configuration of the second link is updated, the first MLD also obtains the updated parameter through one unicast probe request frame and one probe response frame, and does not need to transmit the data frame until the beacon frame is received and the entire BSS configuration is obtained. This helps reduce duration that needs to be waited before the data frame is transmitted, and reduce signaling overheads. In addition, the first MLD sends the unicast probe frame only after learning that the BSS configuration of the second link is updated. Compared with a manner in which the first MLD directly sends a probe request frame without learning whether there is an update, this reduces the waiting time used before the data frame is transmitted in link processing.

Optionally, the first information is a sequence number of the BSS configuration, an access point configuration sequence number (AP-CSN), or a check beacon (check beacon) value that is in the second MLD and that identifies the second link. The second information is the sequence number of the BSS configuration, the access point configuration sequence number (AP-CSN), or the check beacon (check beacon) value that is stored (or recorded) in the first MLD and that identifies the second link. In this way, the first MLD compares whether the first information is consistent with the second information. In response to the first information being consistent with the second information, the BSS configuration of the second link is not updated. In response to the first information being inconsistent with the second information, the BSS configuration of the second link is updated. This helps the first MLD transmit the data frame on the second link in time.

That is, the first information is a sequence number of the current BSS configuration, an AP-CSN, or a check beacon value of the second link. The second information is a sequence number of the BSS configuration, an AP-CSN, or a check beacon value that is of the second link and that is previously obtained by the first MLD. Therefore, in response to the current BSS configuration of the second link not being updated compared with the BSS configuration of the second link that is previously obtained by the first MLD, the first information is equal to the second information. In response to the current BSS configuration of the second link being updated, the first information is not equal to or greater than the second information.

Optionally, the second information is obtained from a beacon (beacon) frame or a multi-link probe response frame of the first link in response to the first MLD performing channel sounding, or is obtained from a multi-link association response frame of the first link in response to the first MLD performs link association. That is, the beacon (beacon) frame, the multi-link probe response frame, or the multi-link association response frame of the first link further carries other information such as the link status and channel utilization of the second link.

Optionally, the beacon frame, the multi-link probe response frame, or the multi-link association response frame of the first link carries information about a plurality of links or all links. In addition to the second information (for example, the AP-CSN or the check beacon value), information about each link further includes but is not limited to one or more of the following: a link status and channel utilization. Therefore, in response to the first MLD performing link switching or link status transition, the first MLD selects, based on the information, a switched-to link or a link whose status is transited.

In at least one embodiment, the first information of the second link is carried in a link switching response message, a cross-link information report message, a medium access control frame, a response frame for negotiating a mapping relationship between a traffic identifier and a link, a beacon frame, a control field of the data frame, or a request frame for negotiating a mapping relationship between a traffic identifier and a link that is received on the first link. In at least one embodiment, the first MLD receives first information of the second link on the first link includes: The first MLD receives, on the first link, the link switching response message, the cross-link information report message, the medium access control frame, or the response frame for negotiating the mapping relationship between the traffic identifier and the link. The first information of the second link is carried in the link switching response message, the cross-link information report message, the medium access control frame, or the response frame for negotiating the mapping relationship between the traffic identifier and the link.

Optionally, the first MLD first sends a link switching request message, a cross-link information report request message, or the request frame for negotiating the mapping relationship between the traffic identifier and the link, so that the second MLD returns the first information of the second link through the foregoing response message. In at least one embodiment, the first MLD actively requests the first information of the switched-to link, to learn whether the BSS configuration of the second link is updated. This helps avoid, after switching or status transition, a problem that the data frame is transmitted only after the beacon frame is received, and reduces the waiting time used before the data frame is transmitted on the switched-to link or the link whose status is transited.

The first MLD sends the request frame for negotiating the mapping relationship between the traffic identifier and the link in response to the first MLD changing the mapping relationship between the link and the traffic identifier, so that link statuses of some links need to be transited from a disable/doze state to an enable/awake state. Correspondingly, the response frame for negotiating the mapping relationship between the traffic identifier and the link returned by the second MLD is further used for indicating whether the second MLD accepts a mapping configuration request between the traffic identifier and the link. In response to the second MLD accepting the mapping configuration request, the response frame for negotiating the mapping relationship between the traffic identifier and the link includes the first information of the second link. In response to the second MLD not accepting the mapping configuration request, the response frame for negotiating the mapping relationship between the traffic identifier and the link does not include the first information of the second link.

IN at least one embodiment, in response to the second MLD changing the mapping relationship between the link and the traffic identifier, the second MLD further needs to transit link statuses of some links from a disable/doze state to an enable/awake state. The second MLD also sends the request frame for negotiating the mapping relationship between the traffic identifier and the link to the first MLD. The request frame for negotiating the mapping relationship between the traffic identifier and the link carries the first information of the second link. In this way, the first MLD transmits the link status based on the first information of the second link in the foregoing implementation, to reduce the waiting time used before the data frame is transmitted.

Correspondingly, the response frame for negotiating the mapping relationship between the traffic identifier and the link returned by the first MLD to the second MLD indicates whether the first MLD accepts a mapping configuration request between the traffic identifier and the link. In response to the first MLD accepting the mapping configuration request, the response frame for negotiating the mapping relationship between the traffic identifier and the link carry information that is confirmed to be accepted. In response to the first MLD not accepting the mapping configuration request, the response frame for negotiating the mapping relationship between the traffic identifier and the link agree on information that is rejected.

The first MLD or the second MLD determine a link whose link status needs to be transited, to determine a quantity of links carried in the request frame for negotiating the mapping relationship between the traffic identifier and the link.

In at least one embodiment, the first information of the second link is carried in various messages, so that the first MLD or the second MLD initiates a link switch request or a link status transition request in time in various scenarios. Therefore, a waiting time used for transmitting a data frame on a switched-to link or a link whose status is transited is further reduced.

According to a second aspect, in at least one embodiment, a link processing method is provided. The link processing method corresponds to the link processing method, and the link processing method is described from a perspective of a second MLD.

In the method, a plurality of links between the second MLD and a first MLD include a first link and a second link. The second link is a link that is switched from the first link by the first MLD or a link whose link status is transited by the first MLD. The second MLD determines first information of the second link. The first information is used by the first MLD to determine whether a basic service set BSS configuration of the second link is updated. The second MLD sends the first information of the second link to the first MLD on the first link. Optionally, the second MLD sends the first information of the second link to the first MLD before the first MLD switches from the first link to the second link or before the link status of the second link is transited.

The method helps the first MLD determine, based on the first information, whether the BSS configuration of the second link is updated. Further, in response to the BSS configuration of the second link not being updated, the first MLD directly transmits a data frame on the switched-to second link or the second link whose status is transited, and does not need to transmit the data frame until a beacon frame is received and a latest parameter of the BSS configuration is obtained on the switched-to second link or the second link whose status is transited. This reduces a waiting time before the data frame is transmitted on the switched-to second link or the second link whose status is transited.

In response to the BSS configuration of the second link not being updated, the second MLD receives an uplink data frame, a quality of service null (QoS NULL) frame, or a link status notification frame from the first MLD on the second link. The link status notification frame indicates that the second link is in an awake or enable state, so that the second MLD delivers a downlink data frame in time.

In at least one embodiment, in response to the BSS configuration of the second link being updated, the second MLD receives second information from the first MLD on the second link, determines an updated parameter of the BSS configuration of the second link based on the second information, and sends the updated parameter of the BSS configuration of the second link to the first MLD on the first link.

Optionally, the first information is a sequence number of the BSS configuration, an access point configuration sequence number (AP-CSN), or a check beacon (check beacon) value that is in the second MLD and that identifies the second link. The second information is a sequence number of the BSS configuration, an access point configuration sequence number (AP-CSN), or a check beacon (check beacon) value that is stored in the first MLD and that identifies the second link. In this way, the first MLD compares whether the first information is consistent with the second information. In response to the first information being consistent with the second information the BSS configuration of the second link is not updated. In response to the first information being inconsistent with the second information, the BSS configuration of the second link is updated. This helps the first MLD transmit the data frame on the second link in time.

That is, the first information is an identifier of the current BSS configuration of the second link. The second information is an identifier of the BSS configuration of the second link that is previously obtained by the first MLD. Therefore, in response to the recently updated or current BSS configuration of the second link not being updated compared with the BSS configuration of the second link that is previously obtained by the first MLD, the first information is equal to the second information. In response to the recently updated or current BSS configuration of the second link being updated, the first information is not equal to or greater than the second information.

In at least one embodiment, the second information of the second link is carried in a unicast probe request frame that is received on the second link. The updated parameter of the BSS configuration of the second link is carried, for sending, in a probe response frame on the second link. The probe response frame is sent based on the unicast probe request frame. That is, that the second MLD receives second information on the second link includes: The second MLD receives the unicast probe request frame on the second link. The unicast probe request frame includes the second information of the second link. The second MLD sends the probe response frame on the second link. The probe response frame includes the updated parameter of the BSS configuration of the second link. The updated parameter of the BSS configuration of the second link is obtained by the second MLD based on the second information.

Optionally, the second information that is of the second link and that is sent to the second MLD is obtained by the first MLD from a beacon (beacon) frame, a multi-link probe response frame, or a multi-link association response frame of the first link in response to the first MLD performing channel sounding or link association. In at least one embodiment, the second MLD sends the beacon (beacon) frame, the multi-link probe response frame, or the multi-link association response frame of the first link on the first link. The beacon frame, the multi-link probe response frame, or the multi-link association response frame includes the second information of the second link. This helps the first MLD report the second information to the second MLD on the second link, to obtain the updated parameter of the BSS configuration of the second link.

Optionally, the beacon (beacon) frame, the multi-link probe response frame, or the multi-link association response frame of the first link further carries information such as the link status and channel utilization of the second link.

In at least one embodiment, the first information of the second link is sent by the second MLD to the first MLD through a link switching response message, a cross-link information report message, a medium access control frame, a response frame for negotiating a mapping relationship between a traffic identifier and a link, a beacon frame, a control field of the data frame, or a request frame for negotiating a mapping relationship between a traffic identifier and a link that is on the first link. That is, that the second MLD sends the first information of the second link on the first link includes: The second MLD sends the link switching response message, the cross-link information report message, the medium access control frame, the response frame for negotiating the mapping relationship between the traffic identifier and the link, the beacon frame, the control field of the data frame, or the request frame for negotiating the mapping relationship between the traffic identifier and the link on the first link. The first information of the second link is carried in the link switching response message, the cross-link information report message, the medium access control frame, the response frame for negotiating the mapping relationship between the traffic identifier and the link, the beacon frame, the control field of the data frame, or the request frame for negotiating the mapping relationship between the traffic identifier and the link.

Optionally, the second MLD first receives a link switching request message, a cross-link information report request message, or the request frame for negotiating the mapping relationship between the traffic identifier and the link from the first MLD on the first link, and then return the foregoing message. In at least one embodiment, the first MLD actively requests the first information of the switched-to link, to learn whether the BSS configuration of the second link is updated. This helps avoid, after switching or status transition, a problem that the data frame is transmitted only after the beacon frame is received, and reduces a waiting time used before the data frame is transmitted on the switched-to link or the link whose status is transited.

The request frame for negotiating the mapping relationship between the traffic identifier and the link from the first MLD is sent in response to the first MLD changing the mapping relationship between the link and the traffic identifier, so that link statuses of some links need to be transited from a disable/doze state to an enable/awake state. Correspondingly, the response frame for negotiating the mapping relationship between the traffic identifier and the link returned by the second MLD is further used for indicating whether the second MLD accepts a mapping configuration request between the traffic identifier and the link. Optionally, in response to the second MLD accepting the mapping configuration request, the response frame for negotiating the mapping relationship between the traffic identifier and the link includes the first information of the second link. In response to the second MLD not accepting the mapping configuration request, the response frame for negotiating the mapping relationship between the traffic identifier and the link does not include the first information of the second link.

In at least one embodiment, in response to the second MLD needs to change the mapping relationship between the link and the traffic identifier, the second MLD further needs to transit link statuses of some links from a disable/doze state to an enable/awake state. The second MLD also sends the request frame for negotiating the mapping relationship between the traffic identifier and the link to the first MLD. The request frame for negotiating the mapping relationship between the traffic identifier and the link carries the first information of the second link. In this way, the first MLD transmits the link status based on the first information of the second link in at least one embodiment, to reduce a waiting time used before the data frame is transmitted.

Correspondingly, the response frame for negotiating the mapping relationship between the traffic identifier and the link received by the second MLD indicates whether the first MLD accepts a mapping configuration request between the traffic identifier and the link. Optionally, in response to the first MLD accepting the mapping configuration request, the response frame for negotiating the mapping relationship between the traffic identifier and the link carries information that is confirmed to be accepted. In response to the first MLD not accepting the mapping configuration request, the response frame for negotiating the mapping relationship between the traffic identifier and the link agrees on information that is rejected.

In at least one embodiment, the first MLD or the second MLD may determine, based on a link whose link status needs to be transited, a quantity of links carried in the request frame for negotiating the mapping relationship between the traffic identifier and the link.

In at least one embodiment, the first information of the second link is carried in various messages, so that the first MLD or the second MLD initiates a link switch request or a link status transition request in time in various scenarios. Therefore, a waiting time used for transmitting a data frame on a switched-to link or a link whose status is transited is further reduced.

According to a third aspect, a link processing method is provided. A difference between the method and the link processing method according to the first aspect lies in that, in this aspect, a second MLD determines whether a BSS configuration of a switched-to second link or the second link whose status is transited is updated. Further, on a first link, an updated parameter of the BSS configuration of the second link is sent to a first MLD, or the first MLD is notified that the BSS configuration of the second link is not updated. In this way, the first MLD directly transmits a data frame on the switched-to second link or the second link whose status is transited, and does not need to transmit the data frame until a beacon frame is further received and a latest parameter of the BSS configuration is obtained on the switched-to second link or the second link whose status is transited. This reduces a waiting time used before the data frame is transmitted on the switched-to second link or the second link whose status is transited.

In addition, in response to a data frame on the first link switching to the second link, in the method, before switching from the first link to the second link, the first MLD learns that the BSS configuration of the second link is not updated or learn the updated parameter of the BSS configuration of the second link. In this way, the data frame is directly transmitted on the switched-to second link, and does not need to be transmitted until a beacon frame is received after switching. This helps shorten impact duration of a link switching process on data frame transmission. In response to a data frame on the first link being offloaded to the second link, in the method, before a status of the second link is transited, the first MLD learns that the BSS configuration of the second link is not updated or learn the updated parameter of the BSS configuration of the second link. Therefore, the data frame is directly transmitted on the second link whose status is transited, and does not need to be transmitted until a beacon frame is received after status transition. This shortens duration used for data frame offloading transmission.

The link processing method includes: The first MLD sends second information of the second link on the first link. The second information is used by the second MLD to determine whether the BSS configuration of the second link is updated. The first MLD receives third information on the first link. The third information is determined by the second MLD based on the second information. The third information indicates that the BSS configuration of the second link is not updated or the updated parameter of the BSS configuration of the second link. In this way, the first MLD directly transmits the data frame on the second link based on the third information. The first MLD directly transmits the data frame on the switched-to second link or the second link whose status is transited. This reduces the waiting time used before the data frame is transmitted on the switched-to second link or the second link whose status is transited.

In response to the BSS configuration of the second link being updated, the third information includes the updated parameter of the BSS configuration of the second link. In response to the BSS configuration of the second link not being updated, the third information indicates that the BSS configuration of the second link is not updated.

The data frame is an uplink data frame or a quality of service null (QoS NULL) frame, to notify the second MLD that the second link is in an awake/enable state. Optionally, the first MLD further transmits a link status notification frame on the second link. The link status notification frame indicates that the second link is in the awake/enable state, so that the second MLD sends a downlink data frame on the second link in time.

The second information is a sequence number of the BSS configuration, an access point configuration sequence number (AP-CSN), or a check beacon (check beacon) value that is stored in the first MLD and that identifies the second link. The first information is a sequence number of the BSS configuration, an access point configuration sequence number (AP-CSN), or a check beacon (check beacon) value that is in the second MLD and that identifies the second link. In this way, the second MLD compares whether the first information is consistent with the second information. In response to the first information being consistent with the second information, the BSS configuration of the second link is not updated. In response to the first information being inconsistent with the second information, the BSS configuration of the second link is updated. This helps the second MLD learn, based on the first information and the second information, whether the BSS configuration of the second link is updated.

That is, the first information is a sequence number of the current BSS configuration, an AP-CSN, or a check beacon value of the second link. The second information is a sequence number of the BSS configuration, an AP-CSN, or a check beacon value that is of the second link and that is previously obtained by the first MLD. Therefore, in response to the recently updated or current BSS configuration of the second link not being updated compared with the BSS configuration of the second link that is previously obtained by the first MLD, the first information is equal to the second information. In response to the recently updated or current BSS configuration of the second link being updated, the first information is not equal to or greater than the second information.

Optionally, the second information is obtained by the first MLD from a beacon (beacon) frame or a multi-link probe response frame of the first link in response to the first MLD performing channel sounding. Alternatively, the second information is obtained by the first MLD from a multi-link probe response frame of the first link in response to the first MLD performing link association.

Optionally, the beacon (beacon) frame, the multi-link probe response frame, or a multi-link association response frame of the first link carries information about a plurality of links or all links. Information about each link includes the second information, and further includes but is not limited to one or more of the following: a link status, channel utilization, and the like. In at least one embodiment, in response to the first MLD performing link switching or link status transition, the first MLD selects, based on the information, a switched-to link or a link whose status is transited.

In at least one embodiment, the first MLD sends a link switching request message, a cross-link information report request message, or a request frame for negotiating a mapping relationship between a traffic identifier and a link on the first link, to notify the second MLD of the second information of the second link. That is, the second information of the second link is carried in the link switching request message, the cross-link information report request message, or the request frame for negotiating the mapping relationship between the traffic identifier and the link.

Correspondingly, the first MLD receives a link switching response message, a cross-link information report message, a medium access control frame, or a response frame for negotiating a mapping relationship between a traffic identifier and a link on the first link, to obtain the third information of the second link. In at least one embodiment, that the first multi-link device (MLD) receives third information on the first link includes: The first MLD receives, on the first link, the link switching response message, the cross-link information report message, the medium access control frame, or the response frame for negotiating the mapping relationship between the traffic identifier and the link. The third information of the second link is carried in the link switching response message, the cross-link information report message, the medium access control frame, or the response frame for negotiating the mapping relationship between the traffic identifier and the link.

The request frame for negotiating the mapping relationship between the traffic identifier and the link from the first MLD is sent in response to the first MLD changing the mapping relationship between the link and the traffic identifier, so that link statuses of some links need to be transited from a disable/doze state to an enable/awake state. Correspondingly, the response frame for negotiating the mapping relationship between the traffic identifier and the link returned by the second MLD indicates whether the second MLD accepts a mapping configuration request between the traffic identifier and the link. Optionally, in response to the second MLD accepting the mapping configuration request, the response frame for negotiating the mapping relationship between the traffic identifier and the link includes the third information of the second link. In response to the second MLD not accepting the mapping configuration request, the response frame for negotiating the mapping relationship between the traffic identifier and the link does not include the third information of the second link.

In at least one embodiment, the first MLD actively reports the second information of the switched-to link, to obtain the third information. This helps avoid, after link switch or status transition, a problem that the data frame is transmitted only after the beacon frame is received, and reduces a waiting time used before the data frame is transmitted on the switched-to link.

According to a fourth aspect, In at least one embodiment, a link processing method is provided. The method corresponds to the link processing method in the third aspect, and this aspect is described from a perspective of a second MLD. According to this aspect, the second MLD determines whether a BSS configuration of a switched-to second link or the second link whose status is transited is updated. Further, on a first link, an updated parameter is sent to a first MLD, or the first MLD is notified that the BSS configuration of the second link is not updated. In this way, the first MLD directly transmits a data frame on the switched-to second link or the second link whose status is transited, and does not need to transmit the data frame until a beacon frame is received and a latest parameter of the BSS configuration is obtained on the switched-to second link or the second link whose status is transited. This reduces a waiting time used before the data frame is transmitted on the switched-to second link or the second link whose status is transited.

In addition, in response to a data frame on the first link being switched to the second link, in the method, before switching from the first link to the second link, the first MLD learns that the BSS configuration of the second link is not updated or learn the updated parameter of the BSS configuration of the second link. In this way, the data frame is directly transmitted on the switched-to second link, and does not need to be transmitted until a beacon frame is received after switching. This shortens impact duration of a link switching process on data frame transmission. In response to a data frame on the first link being offloaded to the second link, in the method, before a status of the second link is transited, the first MLD learns that the BSS configuration of the second link is not updated or learn the updated parameter of the BSS configuration of the second link. Therefore, the data frame is directly transmitted on the second link whose status is transited, and does not need to be transmitted until a beacon frame is received after status transition. This shortens duration used for data frame offloading transmission.

The link processing method includes: The second MLD receives second information of the second link on the first link. The second information is used by the second MLD to determine whether the BSS configuration of the second link is updated. The second MLD sends third information on the first link. The third information is determined by the second MLD based on the second information. The third information indicates that the BSS configuration of the second link is not updated or the updated parameter of the BSS configuration of the second link.

In response to the BSS configuration of the second link being updated, the third information includes the updated parameter of the BSS configuration of the second link. In response to the BSS configuration of the second link is not updated, the third information indicates that the BSS configuration of the second link is not updated.

Because the second MLD notifies the first MLD on the first link whether the BSS configuration of the second link is updated or the updated parameter of the BSS configuration of the second link, the first MLD directly transmits the data frame on the switched-to second link or the second link whose status is transited without waiting for a beacon frame to be received. This reduces the waiting time used before the data frame is transmitted on the switched-to second link or the second link whose status is transited.

Optionally, after sending the third information on the first link, the second MLD further receives a data frame on the second link. The data frame includes an uplink data frame, a quality of service null (QoS NULL) frame, or a link status notification frame. The link status notification frame indicates that the second link is in an awake/enable state, so that the second MLD sends a downlink data frame on the second link in time.

The second information is a sequence number of the BSS configuration, an access point configuration sequence number (AP-CSN), or a check beacon (check beacon) value that is stored in the first MLD and that identifies the second link. The first information is a sequence number of the BSS configuration, an access point configuration sequence number (AP-CSN), or a check beacon (check beacon) value that is in the second MLD and that identifies the second link. In this way, the second MLD compares whether the first information is consistent with the second information. In response to the first information being consistent with the second information, it indicates that the BSS configuration of the second link is not updated. In response to the first information is inconsistent with the second information, the BSS configuration of the second link is updated. This helps the second MLD learn, based on the first information and the second information, whether the BSS configuration of the second link is updated.

That is, the first information is a sequence number of the current BSS configuration, an AP-CSN, or a check beacon value of the second link. The second information is a sequence number of the BSS configuration, an AP-CSN, or a check beacon value that is of the second link and that is previously obtained by the first MLD. Therefore, in response to the recently updated or current BSS configuration of the second link not being updated compared with the BSS configuration of the second link that is previously obtained by the first MLD, the first information is equal to the second information. In response to the recently updated or current BSS configuration of the second link being updated, the first information is not equal to or greater than the second information.

Optionally, the second information is obtained from a beacon (beacon) frame or a multi-link probe response frame of the first link in response to the first MLD performing channel sounding. Alternatively, the second information is obtained from the multi-link probe response frame of the first link in response to the first MLD performing link association.

Optionally, the beacon (beacon) frame, the multi-link probe response frame, or a multi-link association response frame of the first link carries information about a plurality of links or all links. Information about each link includes the second information, and further includes but is not limited to one or more of the following: a link status, channel utilization, and the like. In at least one embodiment, in response to the first MLD performing link switching or link status transition, the first MLD selects, based on the information, a switched-to link or a link whose status is transited.

In at least one embodiment, the second MLD receives a link switching request message, a cross-link information report request message, or a request frame for negotiating a mapping relationship between a traffic identifier and a link from the first MLD on the first link, to obtain the second information of the second link. That is, the second information of the second link is carried in the link switching request message, the cross-link information report request message, or the request frame for negotiating the mapping relationship between the traffic identifier and the link.

Correspondingly, the second MLD sends a link switching response message, a cross-link information report message, a medium access control frame, or a response frame for negotiating a mapping relationship between a traffic identifier and a link on the first link, to send the third information of the second link to the first MLD. That is, the third information of the second link is carried in the link switching response message, the cross-link information report message, the medium access control frame, or the response frame for negotiating the mapping relationship between the traffic identifier and the link.

The request frame for negotiating the mapping relationship between the traffic identifier and the link from the first MLD is sent in response to the first MLD changing the mapping relationship between the link and the traffic identifier, so that link statuses of some links need to be transited from a disable/doze state to an enable/awake state. Correspondingly, the response frame for negotiating the mapping relationship between the traffic identifier and the link returned by the second MLD indicates whether the second MLD accepts a mapping configuration request between the traffic identifier and the link. Optionally, in response to the second MLD accepting the mapping configuration request, the response frame for negotiating the mapping relationship between the traffic identifier and the link includes the third information of the second link. In response to the second MLD not accepting the mapping configuration request, the response frame for negotiating the mapping relationship between the traffic identifier and the link does not include the third information of the second link.

In at least one embodiment, the first MLD actively reports the second information of the switched-to link or the link whose status is transited, to obtain the third information.

In at least one embodiment, the second information and the third information of the second link is carried in various messages, so that the first MLD or the second MLD initiates a link switch request or a link status transition request in time in various scenarios. Therefore, a waiting time used before a data frame is transmitted on a switched-to link or a link whose status is transited is further reduced.

According to a fifth aspect, a multi-link device is provided. The multi-link device includes a plurality of function modules, configured to correspondingly perform the method provided in the first aspect.

According to a sixth aspect, a multi-link device is provided. The multi-link device includes a plurality of function modules, configured to correspondingly perform the method.

According to a seventh aspect, a multi-link device is provided. The multi-link device includes a plurality of function modules, configured to correspondingly perform the method provided in the third aspect.

According to an eighth aspect, a multi-link device is provided. The multi-link device includes a plurality of function modules, configured to correspondingly perform the method provided in the fourth aspect.

According to a ninth aspect, a multi-link device is configured to perform the link processing method described in the first aspect. The multi-link device includes a memory, and a processor and a transceiver that are coupled to the memory. The transceiver is configured to communicate with another communications device (such as a multi-link device). The memory is configured to store code of the link processing method described in the first aspect. The processor is configured to execute program code stored in the memory, that is, perform the method provided in the first aspect.

According to a tenth aspect, a multi-link device is configured to perform the link processing method described in the second aspect. The multi-link device includes a memory, and a processor and a transceiver that are coupled to the memory. The transceiver is configured to communicate with another communications device (such as a multi-link device). The memory is configured to store code of the link processing method described in the second aspect. The processor is configured to execute program code stored in the memory, that is, perform the method provided in the second aspect.

According to an eleventh aspect, a multi-link device is configured to perform the link processing method described in the third aspect. The multi-link device includes a memory, and a processor and a transceiver that are coupled to the memory. The transceiver is configured to communicate with another communications device (such as a multi-link device). The memory is configured to store code of the link processing method described in the third aspect. The processor is configured to execute program code stored in the memory, that is, perform the method provided in the third aspect.

According to a twelfth aspect, a multi-link device is configured to perform the link processing method described in the fourth aspect. The multi-link device includes a memory, and a processor and a transceiver that are coupled to the memory. The transceiver is configured to communicate with another communications device (such as a multi-link device). The memory is configured to store code of the link processing method described in the fourth aspect. The processor is configured to execute program code stored in the memory, that is, perform the method provided in the fourth aspect.

According to a thirteenth aspect, a chip system is provided. The chip system includes a processor, and one or more interfaces coupled to the processor. The processor is configured to invoke, from a memory, a program of the link processing method provided in the first aspect, and execute instructions included in the program. The interface is configured to output a link processing result of the processor.

According to a fourteenth aspect, a chip system is provided. The chip system includes a processor, and one or more interfaces coupled to the processor. The processor is configured to invoke, from a memory, a program of the link processing method provided in the second aspect, and execute instructions included in the program. The interface is configured to output a link processing result of the processor.

According to a fifteenth aspect, a chip system is provided. The chip system includes a processor, and one or more interfaces coupled to the processor. The processor is configured to invoke, from a memory, a program of the link processing method provided in the third aspect, and execute instructions included in the program. The interface is configured to output a link processing result of the processor.

According to a sixteenth aspect, a chip system is provided. The chip system includes a processor, and one or more interfaces coupled to the processor. The processor is configured to invoke, from a memory, a program of the link processing method provided in the fourth aspect, and execute instructions included in the program. The interface is configured to output a link processing result of the processor.

According to a seventeenth aspect, a communications system is provided, including a first multi-link device and a second multi-link device.

The first multi-link device is configured to perform the link processing method provided in the first aspect. The second multi-link device is configured to perform the link processing method provided in the second aspect.

According to an eighteenth aspect, a communications system is provided, including a first multi-link device and a second multi-link device.

The first multi-link device is configured to perform the link processing method provided in the third aspect. The second multi-link device is configured to perform the link processing method provided in the fourth aspect.

According to a nineteenth aspect, a computer-readable storage medium is provided. The readable storage medium stores program code for implementing the link processing method provided in the first aspect. The program code includes execution instructions for running the link processing method provided in the first aspect.

According to a twentieth aspect, a computer-readable storage medium is provided. The readable storage medium stores program code for implementing the link processing method provided in the second aspect. The program code includes execution instructions for running the link processing method provided in the second aspect.

According to a twenty-first aspect, a computer-readable storage medium is provided. The readable storage medium stores program code for implementing the link processing method provided in the third aspect. The program code includes execution instructions for running the link processing method provided in the third aspect.

According to a twenty-second aspect, a computer-readable storage medium is provided. The readable storage medium stores program code for implementing the link processing method provided in the fourth aspect. The program code includes execution instructions for running the link processing method provided in the fourth aspect.

According to a twenty-third aspect, a computer program product is provided including a computer program. In response to the computer program product running on a computer, the computer is enabled to perform the link processing method according to the first aspect.

According to a twenty-fourth aspect, a computer program product is provided including a computer program. In response to the computer program product running on a computer, the computer is enabled to perform the link processing method according to the second aspect.

According to a twenty-fifth aspect, a computer program product is provided including a computer program. In response to the computer program product running on a computer, the computer is enabled to perform the link processing method according to the third aspect.

According to a twenty-sixth aspect, a computer program product is provided including a computer program. In response to the computer program product running on a computer, the computer is enabled to perform the link processing method according to the fourth aspect.

### BRIEF DESCRIPTION OF DRAWINGS

FIG. 1A is a schematic diagram of a structure of a communications system according to at least one embodiment;

FIG. 1B is a schematic diagram of a structure of another communications system according to at least one embodiment;

FIG. 2 is a schematic diagram of a link association method according to at least one embodiment;

FIG. 3 is a schematic diagram of a link switch method according to at least one embodiment;

FIG. 4 is a schematic diagram of a link status transition method according to at least one embodiment;

FIG. 5A is a schematic diagram of a link processing method according to at least one embodiment;

FIG. 5B is a schematic diagram of another link processing method according to at least one embodiment;

FIG. 5C is a schematic diagram of still another link processing method according to at least one embodiment;

FIG. 6 is a schematic diagram of a structure of a beacon frame according to at least one embodiment;

FIG. 7 is a schematic diagram of a structure of a multi-link probe response frame according to at least one embodiment;

FIG. 8 is a schematic diagram of a structure of a link switch element according to at least one embodiment;

FIG. 9 is a schematic diagram of a structure of a link status transition element according to at least one embodiment;

FIG. 10 is a schematic diagram of a structure of a multi-link device according to at least one embodiment;

FIG. 11 is a schematic diagram of a structure of another multi-link device according to at least one embodiment; and

FIG. 12 is a schematic diagram of a structure of a chip according to at least one embodiment.

### DESCRIPTION OF EMBODIMENTS

The following describes the technical solutions in embodiments described herein with reference to the accompanying drawings.

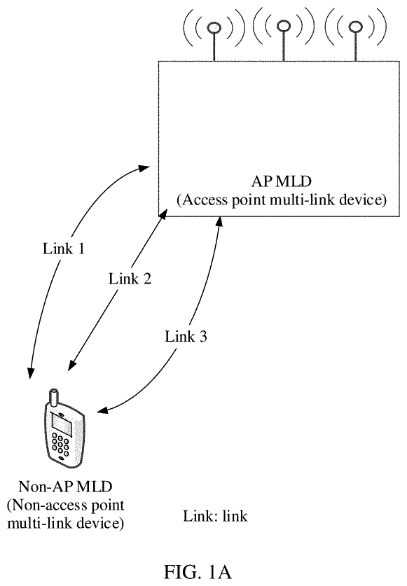

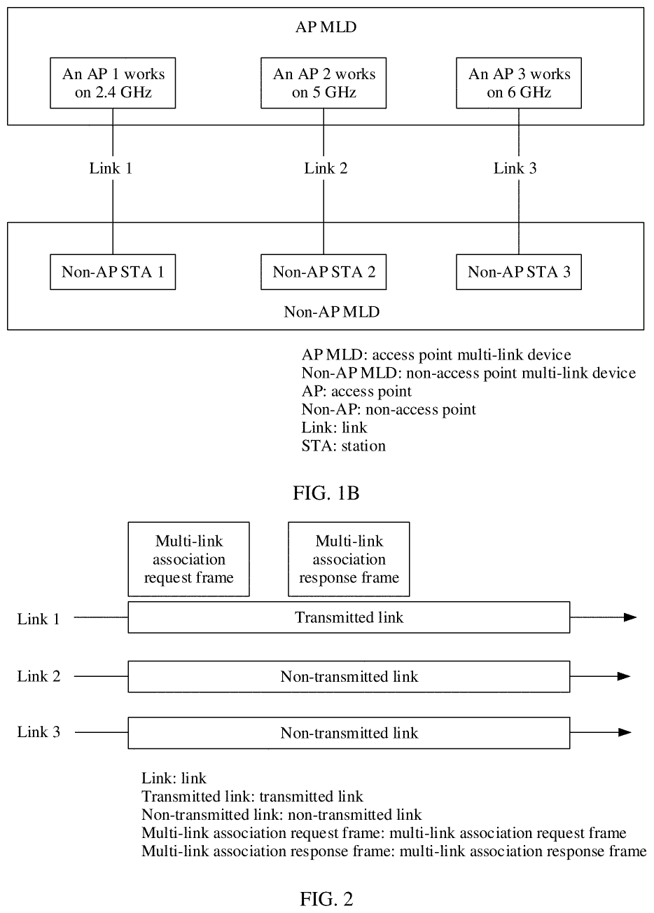

Embodiments described herein provide a link processing method based on a communications system shown in FIG. 1A and FIG. 1B. The method implements fast transition between link statuses or fast switching between links. A communications system 100 shown in FIG. 1A and FIG. 1B includes at least two multi-link devices (multi-link device, MLD). For example, one is an access point (access point, AP) multi-link device, and the other is a non-access point (non-access point, non-AP) multi-link device.

In FIG. 1A, a single-radio non-AP MLD and a multi-radio AP MLD are used as examples. At any moment, the single-radio non-AP MLD has one link to communicate with the AP MLD, and other links are in a disable state. In FIG. 1B, a multi-radio non-AP MLD and a multi-radio AP MLD are used as an example. At any moment, the multi-radio non-AP MLD has one or more links to communicate with the AP MLD. In FIG. 1A and FIG. 1B, for example, the non-AP MLD includes three STAs (for example, a STA 1, a STA 2, and a STA 3) , and the AP MLD includes three Aps (for example, an AP 1, an AP 2, and an AP 3). The STA 1 is associated with the AP 1, and communicates with the AP 1 through a link (link) 1; the STA 2 is associated with the AP 2, and communicates with the AP 2 through a link 2; and the STA 3 is associated with the AP 3, and communicates with the AP 3 through a link 3. In addition, related operations of the non-AP MLD and the AP MLD on the link 1 is correspondingly performed by the STA 1 and the AP 1. For example, “the AP MLD sends first information on the link 1, and the non-AP MLD receives the first information on the link 1” is “the AP 1 sends first information on the link 1, and the STA 1 receives the first information on the link 1. Correspondingly, related operations of the non-AP MLD and the AP MLD on the link 2 is correspondingly performed by the STA 2 and the AP 2. Related operations of the non-AP MLD and the AP MLD on the link 3 is correspondingly performed by the STA 3 and the AP 3. For ease of description, in at least one embodiment, an example in which a non-AP MLD and an AP MLD are separately used as execution bodies is used for description.

### 1. Communications System

In at least one embodiment, the communications system 100 is a wireless local area network (Wireless local area network, WLAN), a cellular network, or another wireless communications system that supports parallel transmission on a plurality of links. In at least one embodiment, a network in which the IEEE 802.11 is deployed is mainly used as an example for description. Various aspects in at least one embodiment is extended to another network that adopts various standards or protocols, for example, BLUETOOTH (Bluetooth), a high-performance radio LAN (high performance radio LAN, HIPERLAN) (a wireless standard similar to the IEEE 802.11 standard, mainly used in Europe), a wide area network (WAN), a wireless local area network (wireless local area network, WLAN), a personal area network (personal area network, PAN), or another network now known or developed in the future. Therefore, the various aspects provided in at least one embodiment is applicable to any suitable wireless network regardless of a coverage area and a wireless access protocol used.

### 2. Multi-Link Device

The multi-link device is a device that works on a plurality of frequency bands or a plurality of channel For example, a frequency band or a channel on which the multi-link device works includes but are not limited to all or a part of sub 1 GHz, 2.4 GHz, 5 GHz, 6 GHz, and a high frequency 60 GHz. The AP MLD and the non-AP MLD in FIG. 1B respectively works on 2.4 GHz, 5 GHz, and 6 GHz. The multichannel is channel division performed based on any frequency band, for example, a 160 MHz channel, an 80 MHz channel, a 40 MHz channel, or a 20 MHz channel at a 5 GHz frequency band. The multi-link device implements wireless communication in compliance with the 802.11 series protocols, for example, in compliance with an extremely high throughput (Extremely High Throughput, EHT) station, or in compliance with an 802.11be-based station or a station that is compatible with 802.11be, to implement communication with another device. The another device is a multi-link device, or is not a multi-link device.

The multi-link device includes one or more affiliated stations STAs (affiliated STA). The affiliated STA is a logical station and works on one link, or a plurality of logical stations work on a same link. The affiliated station is an access point (Access Point, AP) or a non-access point station (non-Access Point Station, non-AP STA). For ease of description, in at least one embodiment, a multi-link device whose affiliated station is an AP is referred to as a multi-link AP, a multi-link AP device, or an AP multi-link device (AP multi-link device) (for example, the AP MLD in FIG. 1A and FIG. 1B). A multi-link device whose affiliated station is a non-AP STA is referred to as a multi-link STA, a multi-link STA device, a STA multi-link device (STA multi-link device), or a non-AP MLD (for example, the non-AP MLD in FIG. 1A and FIG. 1B). For ease of description, “a multi-link device includes an affiliated STA” is also briefly described as “a multi-link device includes a STA” (as shown in FIG. 1A and FIG. 1B) or “a multi-link device includes an AP” in at least one embodiment.

In at least one embodiment, a multi-link device (for example, the AP MLD and the non-AP MLD in FIG. 1A and FIG. 1B) is an apparatus having a wireless communications function. The apparatus is a device of an entire system, or is a chip, a processing system, or the like installed in a device of an entire system. The device on which the chip or the processing system is installed implements a method and a function in at least one embodiment, under control of the chip or the processing system. For example, the multi-link device is a multi-link device with a single antenna (or a single radio frequency module), or is a multi-link device with a plurality of antennas (or a plurality of radio frequency modules). A quantity of antennas included in the multi-link device is not limited in at least one embodiment.

In at least one embodiment, the non-AP MLD (for example, the non-AP MLD in FIG. 1A and FIG. 1B) has a wireless transceiver function, may support the 802.11 series protocols, and communicates with an AP MLD, another non-AP MLD, or a single-link device. For example, the non-AP MLD is any user communications device that allows a user to communicate with an AP and further communicate with a WLAN, including but not limited to, user equipment that is connected to a network, such as a tablet computer, a desktop computer, a laptop computer, a notebook computer, an ultra-mobile personal computer (Ultra-mobile Personal Computer, UMPC), a handheld computer, a netbook, a personal digital assistant (Personal Digital Assistant, PDA), or a mobile phone, or an internet of things node in the internet of things, or a vehicle-mounted communications apparatus in the internet of vehicles, or the like. Optionally, the non-AP MLD is alternatively a chip and a processing system in the foregoing terminals.

In at least one embodiment, the AP MLD (for example, the AP MLD in FIG. 1A and FIG. 1B) is an apparatus that provides a service for the non-AP MLD, and supports the 802.11 series protocols. For example, the AP MLD is a communications entity such as a communications server, a router, a switch, or a bridge, or the AP MLD includes a macro base station, a micro base station, a relay station, and the like in various forms. Certainly, the AP MLD is alternatively a chip and a processing system in the devices in various forms. In this way, the method and the function in at least one embodiment are implemented.

In addition, the multi-link device supports high-rate and low-latency transmission. With continuous evolution of scenarios of a wireless local area network, the multi-link device is further applied to more scenarios, for example, a sensor node (for example, a smart water meter, a smart electricity meter, and a smart air detection node) in a smart city, a smart device (for example, a smart camera, a projector, a display screen, a television, a stereo, a refrigerator, and a washing machine) in a smart home, a node in an internet of things, an entertainment terminal (for example, a wearable device such as an AR and a VR), a smart device (for example, a printer or a projector) in a smart office, an internet of vehicles device in an internet of vehicles, and some infrastructures (for example, a vending machine, a self-service navigation console in a supermarket, a self-service cash register, and a self-service ordering machine) in a daily life scenario. In at least one embodiment, specific forms of the AP MLD and the non-AP MLD are not specially limited, and are merely examples for description herein. The 802.11 protocol is a protocol that supports 802.11be or is compatible with 802.11be.

### 3. Link Identifier

In at least one embodiment, the link identifier represents a link corresponding to a BSS that works on a channel. Optionally, in response to there being a plurality of basic service sets on one channel, a plurality of link identifiers is used to represent a link corresponding to each basic service set (basic service set, BSS).

A link sometimes also represents an AP or a STA working on the link. For ease of description, in some parts of this specification, a link is used to represent a STA on the link. Correspondingly, an operation of a multi-link device on one link is also referred to as an operation of an AP or a STA on the link. That the non-AP MLD receives the first information of the link 2 from the link 1 is also referred to as that the STA 1 in the non-AP MLD receives the first information of the link 2 from the link 1. Correspondingly, the AP MLD is that the AP 1 in the AP MLD sends the first information of the link 2 on the link 1.

The AP MLD and the non-AP MLD determine association relationships between a plurality of STAs of the non-AP MLD and a plurality of Aps of the AP MLD through association operations. For example, in FIG. 2, the non-AP MLD sends a multi-link association request (multi-link association request) frame on the link 1. In addition to carrying information such as a capability of the STA 1, the multi-link association request frame further carries information about the STA 2 and information about the STA 3. The link 1 is referred to as a transmitted link (Transmitted Link). The link 2 and the link 3 are referred to as non-transmitted links (Non-transmitted Link). Correspondingly, the AP MLD returns a multi-link association response (multi-link association response) frame on the link 1. In addition to carrying information such as a basic service set identifier (basic service set identifier, BSSID) of the AP 1, the multi-link association response frame further carries information about the AP 2 and information about the AP 3. In this way, the STA 1, the STA 2, and the STA 3 of the non-AP MLD separately establish associations with the AP 1, the AP 2, and the AP 3 of the AP MLD based on the multi-link association response frame. Therefore, corresponding association relationships shown in FIG. 1A and FIG. 1B are obtained: (the AP 1, the STA 1), (the AP 2, the STA 2), and (the AP 3, the STA 3) . Optionally, FIG. 1A and FIG. 1B use these correspondences as an example. The AP MLD further establishes other corresponding association relationships by changing a sequence of carried information about the AP, for example, (the AP 1, the STA 2), (the AP 2, the STA 1), and (the AP 3, the STA 3) .

In addition, in FIG. 1A, FIG. 1B, FIG. 2, and other subsequent schematic diagrams, the communications system 100 is used as an example for description. For example, the communications system 100 includes an AP MLD and a non-AP MLD. This is intended to describe the technical solutions in embodiments described herein more clearly, and does not constitute a limitation on the technical solutions provided in embodiments described herein. A person of ordinary skill in the art is able to learn that, with evolution of a communications system and emergence of a new service scenario, embodiments described herein are also applicable to a similar technical problem. For example, the communications system including the multi-link device MLD is alternatively a communications system including an AP MLD 1 and an AP MLD 2, or a communications system including a non-AP MLD 1 and a non-AP MLD 2. For another example, the AP MLD includes one or more Aps (an AP 1, an AP 2, . . . , and an AP N). The non-AP MLD includes one or more STAs (a STA 1, a STA 2, . . . , and a STA N). There are a plurality of links (a link 1, a link 2, . . . , and a link N) between the AP MLD and the non-AP. A communications link between the AP 1 and the STA 1 is the link 1, a communications link between the AP 2 and the STA 2 is the link 2, a communication link between the AP N and the STA N is the link N, and the like.

### 4. Link Switch, Link Status Transition, and Problems to be Solved

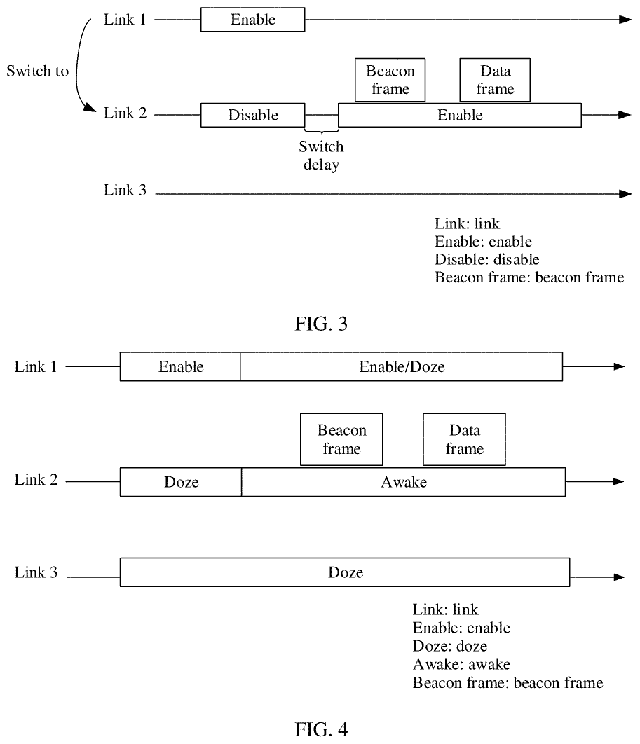

A single-radio multi-link device has a single radio frequency module. Although the single-radio multi-link device works on different frequency bands or channels, the single-radio multi-link device works only on one frequency band or channel at any moment. Therefore, in response to an RSSI (receive signal strength indicator, received signal strength indicator) of a link becoming poor due to movement of the link, the single-radio multi-link device switches from one link to another, for example, from a link deployed on the 5 GHz frequency band to a link deployed on the 2.4 GHz frequency band. As shown in FIG. 3, an assumption is made that the non-AP MLD is a single-radio multi-link device, and the link 1 is in an enable state. In response to a data frame being transmitted on the link 2, the non-AP MLD needs to switch from the link 1 to the link 2. Correspondingly, the link 1 is transited from enable to disable, the link 2 is transited from disable to enable, and the link 3 is always in disable. Because the single-radio multi-link device performs switch between different frequency bands or channels, a related working parameter of the radio frequency module needs to be configured. Therefore, there is a switch delay (switch delay) in response to the link 2 being transited from disable to enable. In addition, in response to the link 2 transmitting the data frame, the STA 2 further needs to obtain a related parameter currently configured by the AP 2 for a BSS corresponding to the link 2. For example, a parameter that is configured by the AP 2 for the BSS corresponding to the link 2 and that is obtained by the STA 2 through the multi-link association response frame shown in FIG. 2 is updated with a current parameter of the BSS configuration of the AP 2, and one or more of parameters shown in Table 1 are updated. Therefore, after the link 2 is transited from disable to enable, the non-AP MLD further needs to correctly receive a beacon (beacon) frame on the link 2. The beacon frame carries the BSS parameter currently configured by the AP 2 for the link 2, so that the data frame is transmitted.

TABLE 1
Part of parameters in the BSS configuration

| | |
|---|---|
| Quiet element | Quiet element |
| BSS Load element | BSS load element |
| BSS Average Access Delay element | BSS average access delay element |
| BSS Available Access Capacity | BSS available access capacity |
| element | element |
| BSS AC Access Delay element | BSS access class access delay |
| | element |
| Time Advertisement element | Time advertisement element |
| beacon Timing element | Beacon timing element |
| AP-CSN element | AP configuration sequence number |
| | element |

For a multi-radio multi-link device, in response to a data volume being relatively small or there is no delay-sensitive service, to reduce energy consumption, a part of links is in a doze (doze) or disable (disable) state. In response to the data volume being relatively large or there is a real-time service, the link in the doze (doze) or disable (disable) state is enabled again, so that the link is in an awake (awake) or enable (enable) state. For example, as shown in FIG. 4, an assumption is made that the non-AP MLD 102 is a multi-radio multi-link device, the link 1 is in an enable state, and the link 2 and the link 3 are in a doze state. In response to a data frame needs to be transmitted on the link 2, the non-AP MLD needs to transit the link 2 from the doze state to the awake state. Because each radio frequency module in the multi-radio multi-link device does not need to reconfigure a related working parameter or the like, in response to the link 2 being transited from the doze state to the awake state, there is no switch delay (switch delay). Because the AP 2 updates a parameter of the BSS configuration in response to the STA 2 being in the doze state, after the STA 2 transits from the doze state to the awake state, the STA 2 needs to correctly receive a beacon (beacon) frame on the link 2. The beacon frame carries the current parameter configured by the AP 2 for the BSS corresponding to the link 2, so that the data frame is transmitted.

Regardless of link status transition in the multi-radio multi-link device or link switch in the single-radio multi-link device, to transmit a data frame, a beacon (beacon) frame needs to be further received on a link whose status is transited or a switched-to link, and a current BSS configuration of a second link needs to be further obtained. This results in an excessively long waiting time used before the data frame is transmitted on the link whose status is transited or the switched-to link. That is, fast transition between link statuses or fast switching between links cannot be implemented.

To resolve the problem, a link processing method is provided. In the link processing method, a first MLD receives first information of a second link on a first link. The first information is used by the first MLD to determine whether a BSS configuration of the second link is updated. In this way, in response to the BSS configuration of the second link not being updated, the first MLD directly transmits a data frame on the second link, to implement fast transition between link statuses of the second link or fast switching from the first link to the second link.

A link processing method is provided. In the link processing method, a second MLD determines whether a BSS configuration of a switched-to second link or the second link whose status is transited is updated. Further, on a first link, an updated parameter is sent to a first MLD, or the first MLD is notified that the BSS configuration of the second link is not updated. In this way, the first MLD directly transmits a data frame on the switched-to second link or the second link whose status is transited without waiting for a beacon frame to be received. This reduces a waiting time used before the data frame is transmitted on the switched-to second link or the second link whose status is transited.

That is, one link processing method is that the first MLD determines whether the BSS configuration of the second link is updated. The other link processing method is that the second MLD determines whether the BSS configuration that is of the second link and that is stored in the first MLD needs to be updated. The foregoing two link processing methods are separately described below in part 6 and part 7. Unless otherwise specified, embodiments described herein are applicable to a single-radio multi-link device, and are also applicable to a multi-radio multi-link device.

### 5. Related Concepts in Described Herein

To facilitate understanding of embodiments described herein, some concepts or nouns are first explained.

A first link is a link in an enable (enable) state in a plurality of links between the non-AP MLD and the AP MLD. A second link is a link in a disable (disable) state or a doze (doze) state in the plurality of links, and the second link is a link to which the non-AP MLD switches from the first link or a link whose link status needs to be transited.

For the single-radio non-AP MLD, the first link is a link in an enable state in the plurality of links. The second link is a switched-to link that is in a disable state in the plurality of links. For the multi-radio non-AP MLD, the first link is a link in an enable state, a link in an awake state, or an anchor (anchor) link in the plurality of links. The second link is a link in a disable state or a doze state in the plurality of links, and the status of the second link needs to be transited from a disable/doze state to an enable/awake state.

For the single-radio non-AP MLD, after the first link is switched to the second link, the first link is in a disable state, and the second link is in an enable state. For the multi-radio non-AP MLD, after the first link is switched to the second link, the second link is in an enable state, but a subsequent state of the first link is not limited. That is, the first link is in a disable/doze/enable/awake state based on a situation. Optionally, for the multi-radio non-AP MLD, there is a plurality of links whose statuses need to be transited. A processing method for each link is the same as the link status transition method for the second link. Optionally, first information and second information of the plurality of links whose statuses need to be transited is carried in one message, or is carried in a plurality of same or different messages.

First information of the second link is used by a first MLD to determine whether a basic service set BSS configuration of the second link is updated. Optionally, the first information is a sequence number of the BSS configuration, an access point configuration sequence number (AP-CSN), or a check beacon (check beacon) value that identifies a latest configuration of a second MLD and that is of the second link.

Second information of the second link is used by the second MLD to determine whether the basic service set BSS configuration of the second link is updated. The second information is a sequence number of the BSS configuration, an access point configuration sequence number (AP-CSN), or a check beacon (check beacon) value that is stored in the first MLD and that identifies the second link.

Optionally, in the link processing method described in part 6 below, second information of a second link is specifically used by a second MLD to determine an updated parameter of a BSS configuration of the second link. In the link processing method described in part 2, the second information is specifically used by the second MLD to determine whether the BSS configuration of the second link is updated and the updated parameter of the BSS configuration of the second link.

An updated parameter of the BSS configuration of the second link described in this specification refers to a parameter that needs to be updated in the BSS configuration of the second link and that is stored in the first MLD compared with a current BSS configuration of the second link in the second MLD. Alternatively, an updated parameter of the BSS configuration of the second link is whether a parameter of the BBS configuration of the second link after the second link is in a disable/doze state is updated compared with a parameter of the BBS configuration of the second link before the second link is in the disable/doze state. Therefore, the first information of the second link is used for assisting the first MLD in determining whether the basic service set BSS configuration of the second link is updated. For example, the first MLD determines, based on the first information and the second information, whether the basic service set BSS configuration of the second link is updated. The second information of the second link is used for assisting the second MLD in determining whether the basic service set BSS configuration of the second link is updated. For example, the second MLD determines, based on the first information and the second information, whether the basic service set BSS configuration of the second link is updated.

In a method described in part 7 below, third information is determined by a second MLD based on second information of a second link, and is sent on a first link. The third information indicates that a BSS configuration of the second link is not updated or indicates an updated parameter of the BSS configuration of the second link. In response to the BSS configuration of the second link not being updated, the third information indicates that the BSS configuration of the second link is not updated. In response to the BSS configuration of the second link being updated, the third information includes the updated parameter of the BSS configuration of the second link.

The BSS configuration indicates a parameter related to the BSS. A station on the link needs to be operated based on the parameter of the BSS configuration. The updated parameter of the BSS configuration includes but is not limited to one or more parameters shown in Table 1. The BSS configuration of the second link in the first MLD is obtained in response to the first MLD performing channel sounding or link association. Therefore, the BSS configuration of the second link in the first MLD is also referred to as an initial BSS configuration of the second link in the first MLD or a BSS configuration of the second link that is stored in the first MLD. Correspondingly, the BSS configuration of the second link in the second MLD is referred to as a current BSS configuration of the second link.

The link processing method in embodiments described herein is applied to but is not limited to the communications systems shown in FIG. 1A to FIG. 4. For ease of description, an example in which the first MLD is a non-AP MLD and the second MLD is an AP MLD is used. In addition, for a first link and a second link included in a plurality of links between the AP MLD and the non-AP MLD, a link 1 and a link 2 is separately used as an example. The link 2 is a switched-to link from the link 1 or a link whose status is transited. That is, the link 1 is in an enable state, and the link 2 is in a doze/disable state, and the link 2 needs to be transited from a doze/disable state to an awake/enable state. A status of a link 3 is not discussed.

### 6. Link Processing Method

(1) Link Processing Method that a BSS Configuration of a link 2 is Not Updated

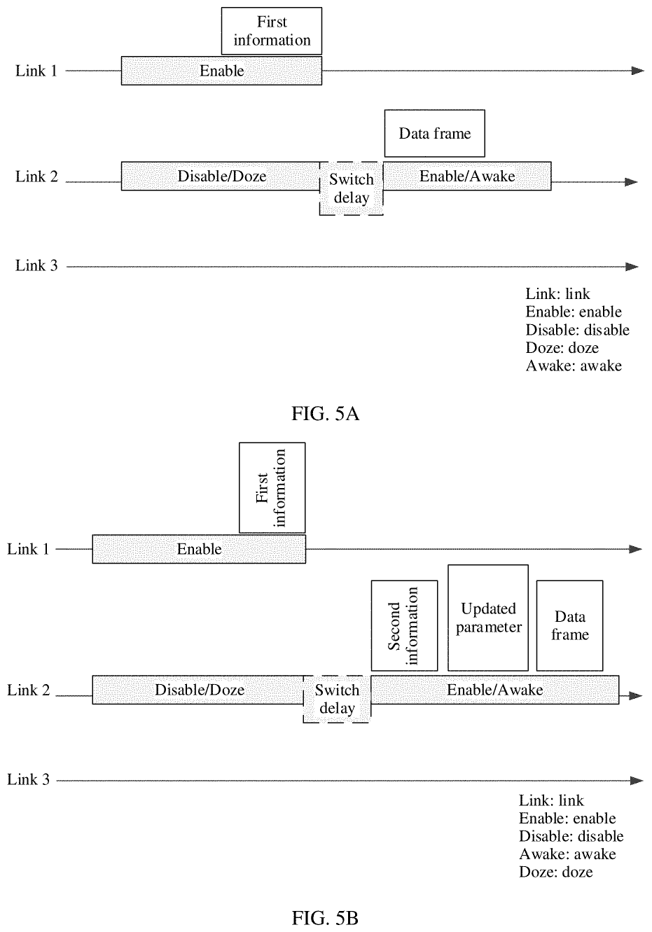

FIG. 5A is a schematic diagram of a link processing method according to at least one embodiment. The link processing method includes the following steps.

101: An AP MLD determines first information of a link 2. The first information is used by a non-AP MLD to determine whether a BSS configuration of the link 2 is updated.

102: The AP MLD sends the first information of the link 2 on a link 1.

103: The non-AP MLD receives the first information of the link 2 on the link 1. In response to the BSS configuration of the link 2 not being updated, the non-AP MLD performs step 104.

104: The non-AP MLD uses the link 2 to transmit a data frame.

Step 101 is an optional step. Optionally, in response to the non-AP MLD being a multi-link device on a single link, there is a switch delay before the data frame is transmitted by using the link 2; in response to the non-AP MLD being a multi-link device on a plurality of links, there is no switch delay. In addition, in step 104, in response to the non-AP MLD transmitting the data frame by using the link 2, a BSS configuration that is used is the BSS configuration of the link 2 in the non-AP MLD.

The data frame is an uplink data frame, a quality of service null (QoS NULL) frame, or a link status notification frame. The link status notification frame indicates that the second link is in an awake/enable state, so that the second MLD sends a downlink data frame on the second link in time. Optionally, the uplink data frame or the quality of service null (QoS NULL) frame also indicates that the second link is in the awake/enable state.

As shown in FIG. 5A, because the BSS configuration of the link 2 is not updated, the non-AP MLD directly transmits the data frame on the switched-to link 2, and does not need to transmit the data frame until a beacon frame on the link 2 is received after switching or status transition. According to a processing method shown in FIG. 3 or FIG. 4, a waiting time used before the data frame is transmitted on the link 2 is reduced.

Optionally, after step 103, the non-AP MLD switches to the link 2 or transit the status of the link 2 to the awake/enable state based on the first information of the link 2.

(2) Link Processing Method that the BSS Configuration of the link 2 is Updated

In at least one embodiment, in step 104, in response to the BSS configuration of the link 2 being updated, as shown in FIG. 5B, a difference between the link processing method and the link processing method shown in FIG. 5A lies in that the BSS configuration of the link 2 is updated, and the following steps is performed.

105: The non-AP MLD sends second information to the AP MLD on the link 2. The second information is a sequence number of the BSS configuration, an access point configuration sequence number (AP-CSN), or a check beacon (check beacon) value that identifies the link 2 in the non-AP MLD.

106: The AP MLD receives the second information, and sends, on the link 2 based on the second information, an updated parameter of the BSS configuration of the link 2.

As shown in FIG. 5C, the second information in FIG. 5B is carried in a unicast probe request (probe request) frame on the link 2. Third information is carried in a probe response (probe response) frame on the link 2. At least one embodiment is as follows: The non-AP MLD sends the unicast probe request frame to the AP MLD on the link 2. The unicast probe request frame includes the second information. The non-AP MLD receives the probe response frame from the AP MLD on the link 2. The probe response frame is a simplified probe response frame and includes the updated parameter of the BSS configuration of the link 2. The updated parameter of the BSS configuration of the link 2 is determined by the AP MLD based on the second information.

For example, the AP MLD determines which parameters are updated in the current BSS configuration of the link 2 (that is, the BSS configuration of the link 2 corresponding to the first information) compared with the BSS configuration of the link 2 corresponding to the second information, and returns all updated parameters or updated key parameters in the probe response frame to the non-AP MLD.

107: The non-AP MLD receives the updated parameter of the BSS configuration of the link 2.

Further, the link processing method further includes: The non-AP MLD updates the BSS configuration of the link 2 in the non-AP MLD by using the updated parameter of the BSS configuration of the link 2, and transmits the data frame on the link 2 based on an updated BSS configuration of the link 2. The non-AP MLD further correspondingly updates the sequence number of the BSS configuration/AP-CSN/check beacon value that identifies the link 2.

Correspondingly, in response to the BSS configuration of the link 2 not being updated, step 104 is: The non-AP MLD transmits the data frame on the link 2 by using the BSS configuration of the link 2 in the non-AP MLD.

As shown in FIG. 5B, in response to the BSS configuration of the link 2 being updated, the non-AP MLD needs to send the second information, and receive the updated parameter of the BSS configuration of the link 2, so that the data frame is transmitted on the link 2. In at least one embodiment, the first MLD sends the unicast probe frame only after learning that the BSS configuration of the second link is updated, and does not need to send the unicast probe request frame regardless of whether there is an update. Therefore, in at least one embodiment, a waiting time used before the data frame is transmitted in a link processing process is reduced.

In at least one embodiment, in response to the BSS configuration of the link 2 being updated, the non-AP MLD receives a beacon frame on the link 2, and after correctly receiving the beacon frame, transmit the data frame based on a parameter that is of the BSS configuration and that is carried in the beacon frame. At least one embodiment described herein is combined with FIG. 5A, to avoid a problem that a waiting time is excessively long because the data frame is transmitted only after the beacon frame is received. Therefore, the waiting time used before the data frame is transmitted on the link 2 is reduced.

In step 103, how the non-AP MLD determines whether the BSS configuration of the link 2 is updated based on the first information is: The non-AP MLD determines whether the first information is consistent with the second information. In response to the first information is consistent with the second information, the BSS configuration of the link 2 is not updated. In response to the first information is inconsistent with the second information, the BSS configuration of the link 2 is updated. The first information is a sequence number of the BSS configuration, an AP-CSN, or a check beacon value that is in the AP MLD and that identifies the second link. The second information is a sequence number of the BSS configuration, an AP-CSN, or a check beacon value that is in the non-AP MLD and that identifies the second link.

For example, the first information is an AP-CSN 1, and the second information is an AP-CSN 2. In response to the AP-CSN 1 being equal to the AP-CSN 2, the BSS configuration of the link 2 corresponding to the AP-CSN 1 is not updated compared with the BSS configuration of the link 2 corresponding to the AP-CSN 2. That is, the BSS configuration of the link 2 is not updated. In response to the AP-CSN 1 is not equal to or greater than the AP-CSN 2, the BSS configuration of the link 2 corresponding to the AP-CSN 1 is updated compared with the BSS configuration of the link 2 corresponding to the AP-CSN 2. That is, the BSS configuration of the link 2 is updated. Further, the updated parameter that is updated in the BSS configuration of the link 2 is obtained through the foregoing steps 105 to 107.

In at least one embodiment, the second information of the link 2 in the non-AP MLD is obtained and stored by the non-AP MLD from a beacon (beacon) frame or a probe response frame of the link 1, or is obtained and stored by the non-AP MLD from a multi-link association response frame of the link 1. Therefore, before the non-AP MLD switches a link to the link 2 or transits the link status of the link 2, the non-AP MLD compares the second information with the first information, to determine whether the BSS configuration of the link 2 is updated.

In addition to carrying the second information of the link 2, the beacon (beacon) frame, the probe response frame, or the multi-link association response frame of the link 1 further carries other information of the link 2 and related information of another link. Descriptions are separately provided in the following.

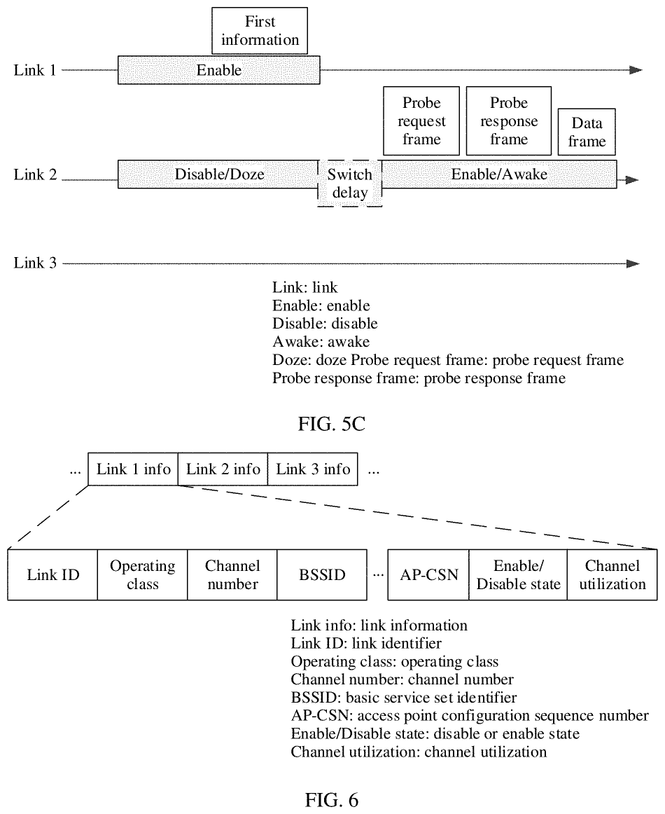

For example, as shown in FIG. 6, the second information is an AP-CSN. The beacon frame of the link 1 carries one or more types of information including but not limited to the following: an enable/disable state of each link, an AP-CSN of each link, channel utilization (channel utilization) of a link in an enable state, a quantity of stations of a link in enable state, a link identifier (link ID), an operating class (operating class), a channel number (channel number), and a basic service set identifier (BSSID). The enable/disable state of each link indicates whether an AP of each link in the AP MLD is enabled. The AP-CSN of each link is used for assisting the non-AP MLD in performing link switching or link status transition in the foregoing link processing. The channel utilization of the link in an enable state is used for selecting a link in response to the non-AP MLD recommending link switching, or used for selecting a recommended or used link in response to the non-AP MLD recommending link status transition. The quantity of stations of the link in an enable state is used for assisting the non-AP MLD in evaluating a congestion degree of an AP based on a quantity of stations connected to the AP of the link.

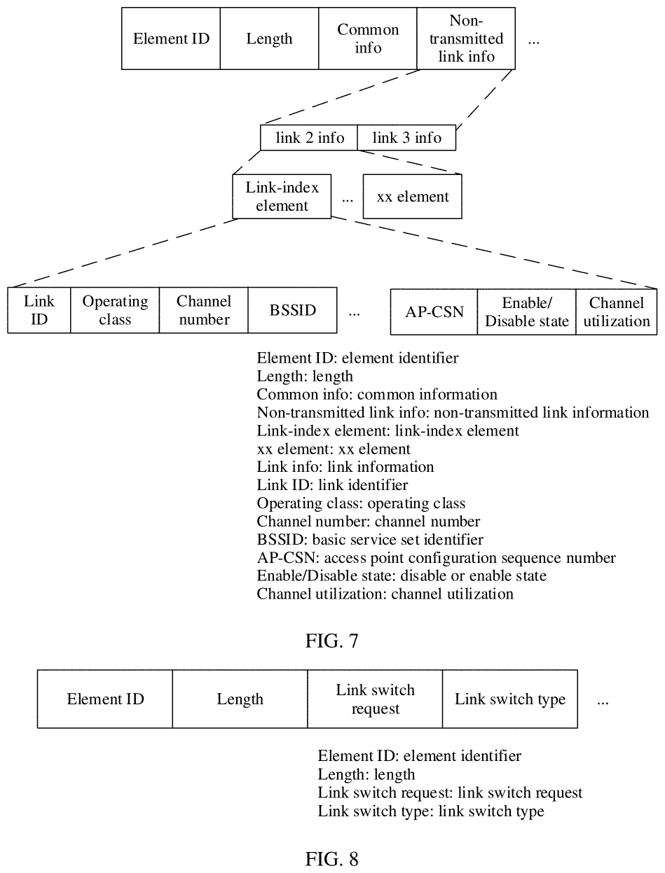

The probe response frame is a multi-link probe response (multi-link probe response) frame. A manner of indicating the information about each link carried in the multi-link probe response frame is similar to that of indicating the information about each link carried in the multi-link association response frame. For example, an element in which information about a non-transmitted link is different from information about a transmitted link is carried in a link-index element (link-index element) of each non-transmitted link. For example, as shown in FIG. 7, the link 1 is a transmitted link. Therefore, a link-index element (link-index element) of a non-transmitted link does not include information about the link 1. Correspondingly, in addition to carrying an enable/disable state of a link, an AP-CSN of a link, channel utilization (channel utilization) of a link in enable state, a quantity of stations of a link in enable state, a link identifier (link ID), an operating class (operating class), a channel number (channel number), and a basic service set identifier (BSSID), a link-index element shown in FIG. 7 further carries a timestamp (timestamp), a beacon interval (beacon Interval), and a capability information indication (capability information).

Optionally, the multi-link probe request (multi-link probe request) frame or the multi-link association request frame carries a quantity of radio frequencies of a device and a link status. The quantity of radio frequencies of the device indicates whether the link shares a radio frequency with another link. For example, the link uses 1 bit to indicate whether the link shares one radio frequency with a previous link. The previous link refers to that in response to a plurality of pieces of link information being indicated, a link status of the previous link of the link is disable or enable. In response to the link status being enable, the link is in an awake state or a doze state is further indicated.

Optionally, a correspondence between an arrangement sequence of the information about each link in the multi-link association request frame and an arrangement sequence of the information about each link in the multi-link association response frame is used for determining an association status between each STA in the non-AP MLD and each AP in the AP MLD. Therefore, the AP MLD adjusts an arrangement location or order of the information about each link in the multi-link association response frame, to change the association status between each STA and each AP.

There is a possibility of multi-link aggregation: Only BSSs belonging to a same service set identifier (service set identifier, SSID) are allowed to be aggregated. That is, a data packet of one traffic identifier (traffic identifier, TID) is allowed to be transmitted through a plurality of links. That is, a TID is mapped to the plurality of links. Therefore, in the multi-link association request shown in FIG. 7, the non-transmitted link profile information (Non-transmitted link profile info) does not need to carry an SSID element.

In step 102, the first information of the second link is carried in a link switch response (link switch response) message, a cross-link information report (cross-link info report) message, a medium access control (MAC control) frame, or a traffic identifier-to-link mapping negotiation response (TID-to-link mapping negotiation response) message of the first link. Optionally, after step 103, the non-AP MLD switches from the link 1 to the link 2 or transit the state of the link 2 to an awake/enable state based on the link switch response message, the cross-link info report message, or the TID-to-link mapping negotiation response message.

Optionally, after receiving the cross-link info report message, the non-AP MLD returns an acknowledge (ACK) message to the AP MLD on the link 1. Optionally, in response to the cross-link information (cross-link info) being carried in an A-control (control) field in the MAC control frame, after receiving the MAC control frame, the non-AP MLD does not return an acknowledge (ACK) message.

The link switch response message is returned by the AP MLD in response to a link switch request (link switch request) message from the non-AP MLD. The TID-to-link mapping negotiation response message is returned by the AP MLD in response to a TID-to-link mapping negotiation request (TID-to-link mapping negotiation request) message sent by the non-AP MLD. Optionally, the cross-link information report (cross-link info report) message is returned by the AP MLD in response to a cross-link information request (cross-link info request) message sent by the non-AP MLD. Therefore, in response to link quality of the link 1 deteriorating, or the cross-link info needs to be learned to assist in link switch, a STA in the non-AP MLD or the non-AP MLD initiates a link switch request or a cross-link information request. That is, before step 101, the non-AP MLD first sends the request message to request link switch or link status transition, to perform steps 102 to 107. The request messages and response messages help the non-AP MLD initiate a request for link switch or link status transition in a plurality of scenarios, and transmit a data frame on a switched-to link or a link whose status is transited in time.

### 3. Link Switch Method Initiated by the Non-AP MLD and Responded by the AP MLD

In the link switch method, the non-AP MLD initiates a request by using the link switch request message, the cross-link info request message, or the TID-to-link mapping negotiation request message. The AP MLD responds or answer by using the corresponding link switch response message, the cross-link info report message, or the TID-to-link mapping negotiation response message. Different request modes for link switch determine information carried in these request messages. Correspondingly, different answer modes also determine information carried in these response messages. However, with reference to the foregoing embodiments, these response messages carry at least the first information of the switched-to link. The following optional request modes and answer modes greatly improve flexibility of a link switch operation, and facilitate use of a corresponding request mode and answer mode based on a specific scenario.

The link switch response message and the cross-link info report message carry information to indicate whether the AP MLD accepts a link switch request initiated by the non-AP MLD. The TID-to-link mapping negotiation response message indicates whether the AP MLD accepts a mapping configuration request between the traffic identifier and the link initiated by the non-AP MLD. The mapping configuration request between the traffic identifier and the link is actually a link switch request. Therefore, the TID-to-link mapping negotiation response message indicates whether the AP MLD accepts the link switch request initiated by the non-AP MLD.

As shown in Table 2, the request mode of the non-AP MLD includes but is not limited to one or more of the following: (1a) Request link switch and provide no switched-to target link; (2a) recommend link switch and provide one or more switched-to target links; and (3a) involve a link switch, provide a switched-to target link, and accept no modification on the switched-to target link. Correspondingly, the answer mode of the AP MLD includes but is not limited to one or more of the following: (1b) Accept link switch and indicate a switched-to target link; (2b) change a recommended switched-to target link, that is, accept no requested or recommended switched-to target link by the non-AP MLD, and provide one or more recommended target links additionally; (3b) accept no requested switched-to target link by the non-AP MLD, indicate an only switched-to target link, and indicate that the non-AP MLD only switches to the target link; and (4b) reject link switch, and optionally, the rejection reason is further indicated. The target link described in this part is a switched-to link, that is, the second link in the foregoing embodiments, for example, the link 2.

As shown in Table 2, for the request mode (1a), optional answer modes include the answer mode 1b) and the answer mode (4b). For the request mode (2a), optional answer modes include the answer mode (1b), the answer mode (2b), the answer mode (3b), and the answer mode (4b). For the request mode (3a), optional answer modes include the answer mode (1b) and the answer mode (4b). For different request modes, the following describes information that is carried in the link switch request message, the cross-link info request message, and the TID-to-link mapping negotiation request message, corresponding answer modes, and information that is carried in the link switch response message, the cross-link info report message, and the TID-to-link mapping negotiation response message. That is, the link switch response message, the cross-link info report message, and the TID-to-link mapping negotiation response message not only carry the first information of the link 2, but also carries other information of the link 2 or information of another link.

TABLE 2

| Optional request modes | Optional answer modes |
|---|---|
| of the non-AP MLD | of the AP MLD |
| (1a) Request link switch and | (1b) Accept link switch and |
| provide no switched-to target | indicate a switched-to target |
| link. | link. |
| | (4b) Reject link switch. |
| (2a) Recommend link switch and | (1b) Accept link switch and |
| provide one or more switched-to | indicate one of the switched-to |
| target links. | target links. |
| | (2b) Change a recommended |
| | switched-to target link. |
| | (3b) Accept no requested |
| | switched-to target link by the |
| | non-AP MLD, and indicate an |
| | only switched-to target link. |
| | (4b) Reject link switch. |
| (3a) Require link switch, provide | (1b) Accept link switch and |
| a switched-to target link, and | indicate one of switched-to |
| accept no modification on the | target links. |
| switched-to target link. | (4b) Reject link switch. |

For the request mode (1a), the link switch request message, the cross-link info request message, or the TID-to-link mapping negotiation request message carries a reason indication for link switch (reason code for link switch) used for notifying the AP MLD of the reason for link switch. For example, the reason for link switch is that a received signal strength indicator (Received signal strength indicator, RSSI) is poor, a delay is long, a request is made to change a traffic identifier-to-link mapping (TID-to-link mapping), or a real-time service is enabled, or the like.

Correspondingly, for the answer mode (1b) of the request mode (1a), the link switch response message, the cross-link info report message, or the TID-to-link mapping negotiation response message returned by the AP MLD includes but is not limited to one or more types of the following information: a status indication (status code), a link identifier of a switched-to target link, and first information. The status indication (status code) indicates whether the AP MLD accepts a link switch request of the non-AP MLD. For example, in response to the AP MLD accepting the link switch request of the non-AP MLD, the link switch response message, the cross-link info report message, or the TID-to-link mapping negotiation response message further carries the link identifier of the switched-to target link and the first information (such as the AP-CSN).

For the answer mode (4b) of the request mode (1a), the link switch response message, the cross-link info report message, or the TID-to-link mapping negotiation response message returned by the AP MLD includes but is not limited to one or more types of the following information: a status indication (status code) of rejecting a link switch request, and a rejection reason.

For the request mode (2a), the link switch request message, the cross-link info request message, or the TID-to-link mapping negotiation request message carries information including but not limited to the following: a reason for link switch, and a link identifier of a switched-to target link.

Correspondingly, for the answer mode (1b) of the request mode (2a), the link switch response message, the cross-link info report message, or the TID-to-link mapping negotiation response message returned by the AP MLD includes but is not limited to one or more types of the following information: a status indication (status code), and first information of the requested target link.

For the answer mode (2b) of the request mode (2a), the link switch response message, the cross-link info report message, or the TID-to-link mapping negotiation response message returned by the AP MLD includes but is not limited to one or more pieces of the following information: additionally provided link identifiers of one or more target links that is switched to, and related information of these target links. The related information of the target link includes first information, a link switch mode (Link Switch mode), a count of link switch or an offset of a target switch time, a link identifier, channel utilization, and a quantity of STAs. In this answer mode, the non-AP MLD further needs to perform operations in steps 104 to 107 in the foregoing embodiment based on the first information, so that the AP MLD learns a switched-to target link finally selected by the non-AP MLD through a link used by the non-AP MLD to transmit a data frame. That is, in at least one embodiment, the non-AP MLD decides to switch to a link recommended by the AP-MLD. Therefore, the link switch response message, the cross-link info report message, or the TID-to-link mapping negotiation response message includes information about all recommended links to assist the non-AP MLD in a decision.

The link switch mode indicates a transmission limitation before link switch. In response to the link switch mode being set to 1 a station stops transmission before link switch. In response to the link switch mode being set to 0, station transmission is not limited. The count of link switch indicates a quantity of beacon frames sent before a new link is switched to. In response to the count of link switch being set to 1, link switch occurs just before a sending moment of a next beacon frame. In response to the count of link switch being set to 0, link switch occurs at any moment after a frame including the information is sent. Alternatively, the count of link switch indicates the offset (offset) of the target switch time. Optionally, for the offset of the target switch time, a sending time of a next beacon frame on a switched-to link needs to be considered. In this way, for the foregoing embodiments in which the beacon frame on the switched-to link is to be received, this helps avoid that the non-AP MLD waits for an excessively long time. The channel utilization and the quantity of STAs are used by the non-AP MLD to learn a quantity of STAs connected to the target link and channel conditions.

For the answer mode (3b) of the request mode (2a), the link switch response message, the cross-link info report message, or the TID-to-link mapping negotiation response message returned by the AP MLD includes but is not limited to the following information: a link identifier and related information of an only switched-to target link. The related information of the target link includes but is not limited to one or more pieces of the following information: first information, a link switch mode (Link Switch mode), a count of link switch or an offset of a target switch time, a link identifier, channel utilization, and a quantity of STAs.

For the answer mode (4b) of the request mode (2a), the link switch response message, the cross-link info report message, or the TID-to-link mapping negotiation response message returned by the AP MLD includes but is not limited to one or more types of the following information: a status indication (status code) of rejecting a link switch request, and a rejection reason.

For the request mode (3a), the link switch request message, the cross-link info request message, or the TID-to-link mapping negotiation request message carries a reason indication for link switch (reason code for link switch), and a link identifier of a target link that is to be switched to.

Correspondingly, for the answer mode (1b) of the request mode (3a), the link switch response message, the cross-link info report message, or the TID-to-link mapping negotiation response message returned by the AP MLD includes but is not limited to one or more types of the following information: a status indication (status code) of accepting a link switch request, a link identifier of the target link, first information of the target link, a link switch mode, a count of link switch or an offset of a target switch time, channel utilization, and a quantity of STAs.

For the answer mode (4b) of the request mode (3a), the link switch response message, the cross-link info report message, or the TID-to-link mapping negotiation response message returned by the AP MLD includes but is not limited to one or more types of the following information: a status indication (status code) of rejecting a link switch request, and a rejection reason.

### 4. Link Status Transition Method Initiated by the Non-AP MLD and Responded by the AP MLD

In the link status transition method, the non-AP MLD initiates a request by using the link switch request message, the cross-link info request message, or the TID-to-link mapping negotiation request message. The AP MLD responds or answer by using the corresponding link switch response message, the cross-link info report message, or the TID-to-link mapping negotiation response message. This is the same as that of the link switch method that is initiated by the non-AP MLD and responded by the AP MLD in the point 3. An only difference is that in the point 3, the target link is a switched-to link, and a target link is a link whose status is transited. Therefore, for related content, “switch” in the foregoing Table 2 and related content is changed to “status transition”, as shown in Table 3. For information that is carried in each request message and each response message and that is described based on Table 3, refer to related content in Table 2. Details are not described herein again.

The link switch response message and the cross-link info report message carry information to indicate whether the AP MLD accepts a status transition request initiated by the non-AP MLD. The TID-to-link mapping negotiation response message indicates whether the AP MLD accepts a mapping configuration request between the traffic identifier and the link initiated by the non-AP MLD. Optionally, the mapping configuration request between the traffic identifier and the link is actually a link switch request. Therefore, the TID-to-link mapping negotiation response message indicates whether the AP MLD accepts the link status transition request initiated by the non-AP MLD.

TABLE 3

| Optional request modes | Optional answer modes |
|---|---|
| of the non-AP MLD | of the AP MLD |
| (1a) Recommend status transition, | (1b) Accept status transition |
| and recommend one or more target | and indicate a target link whose |
| links whose statuses are | status is transited. |
| transited. | (4b) Reject status transition. |
| (2a) Recommend link status | (1b) Accept status transition |
| transition and provide one or | and indicate one of the target |
| more target links whose statuses | links whose statuses are |
| are transited. | transited. |
| | (2b) Change a recommended |
| | target link whose status is |
| | transited. |
| | (3b) Accept no target link whose |
| | status is transited that is |
| | requested by the non-AP MLD, |
| | and indicate an only target |
| | link whose status is transited. |
| | (4b) Reject link status |
| | transition. |
| (3a) Require link status | (1b) Accept link status |
| transition, provide a target link | transition and indicate one |
| whose status is transited, and | of switched-to target links. |
| accept no modification on the | (4b) Reject link status |
| target link whose status is transited. | transition. |

### 5. Link Status Transition Method Initiated by the AP MLD and Responded by the Non-AP MLD

In at least one embodiment, because a request is initiated by the AP MLD, a request message sent by the AP MLD needs to carry first information of a link whose status is transited. Correspondingly, the non-AP MLD returns a response message. The response message indicates whether the non-AP MLD accepts the request. In response to the non-AP MLD not accepting the request, the response message carries a rejection reason parameter. In response to the non-AP MLD accepting the request, the response message carries a link identifier of an accepted target link, or does not carry the link identifier of the accepted target link and indicate that the link status transition request is accepted.

The following describes request modes, answer modes, and information that is carried by using an example in which the AP MLD initiates a request by using the TID-to-link mapping negotiation request message and the non-AP MLD responds with the TID-to-link mapping negotiation response message. The TID-to-link mapping negotiation response message indicates whether the non-AP MLD accepts a mapping configuration request between the traffic identifier and the link initiated by the AP MLD. Optionally, the mapping configuration request between the traffic identifier and the link actually is a link status transition request. Therefore, the TID-to-link mapping negotiation response message indicates whether the non-AP MLD accepts the link status transition request initiated by the AP MLD.

TABLE 4

| Optional request modes | Optional answer modes |
|---|---|
| of the AP MLD | of the non-AP MLD |
| (1a) Recommend status transition, | (1b) Accept status transition |
| and recommend one or more target | of all recommended target links |
| links whose statuses are | whose statuses are transited. |
| transited. | (2b) Accept status transition of |
| | one or more of the recommended |
| | target links whose statuses are |
| | transited. |
| | (3b) Reject status transition. |
| (2a) Require status transition, | (1b) Accept status transition |
| use one or more target links | of all recommended target links |
| whose statuses are transited, | whose statuses are transited. |
| and accept no modification on | (3b) Reject status transition. |
| the target link. | |

As shown in Table 4, the request mode of the AP MLD includes but is not limited to one or more of the following: (1a) Recommend status transition, and recommend one or more target links whose statuses are transited; and (2a) perform status transition, use one or more target links whose statuses are transited, and accept no modification on the target link. Correspondingly, the answer mode of the non-AP MLD includes but is not limited to one or more of the following: (1b) Accept status transition of all recommended target links whose statuses are transited; (2b) accept status transition of one or more of the recommended target links whose statuses are transited; and (3b) reject status transition, and optionally, the rejection reason is further indicated. The target link described in this part is a link that needs to be transited from a disable or doze state to an enable or awake state, that is, the second link in the foregoing embodiments, for example, the link 2.

For the request mode (1a), optional answer modes include the answer mode (1b), the answer mode (2b), the answer mode (3b). For the request mode (2a), optional answer modes include the answer mode (1b) and the answer mode (3b). For different request modes, the following describes information that is carried in a TID-to-link mapping negotiation request frame, a part of corresponding answer modes, and information that is carried in the TID-to-link mapping negotiation response frame.

For the request mode (1a), the TID-to-link mapping negotiation request frame carries a reason indication for link status transition (reason code for link status switch), and related information of one or more target links whose statuses are transited. In addition to first information (for example, a current AP-CSN of the target link), the related information of the target link further includes a link identifier, network allocation vector (network allocation vector, NAV) information, channel utilization, a quantity of STAs, and a link policy.

For the answer mode (1b) corresponding to the request mode (1a), the TID-to-link mapping negotiation response frame carries a status indication. The status indication indicates that the non-AP MLD accepts link status transition and status transition of recommended target links.

For the answer mode (2b) corresponding to the request mode (1a), the TID-to-link mapping negotiation response frame carries a status indication and link identifiers of one or more target links. The status indication indicates that the non-AP MLD accepts link status transition requested by the AP MLD. The link identifiers of the one or more target links are selected by the non-AP MLD from target links recommended by the AP MLD.

For the answer mode (3b) corresponding to the request mode (1a), the TID-to-link mapping negotiation response frame carries a status indication. The status indication indicates that the non-AP MLD does not accept requested status transition. Further, the TID-to-link mapping negotiation response frame further carries a rejection reason.

### 6. Link Switch Method Initiated by the AP MLD and Responded by the Non-AP MLD

In at least one embodiment, because a request is initiated by the AP MLD, a request message sent by the AP MLD needs to carry first information of a switched-to link. Correspondingly, the non-AP MLD returns a response message. The response message indicates whether the non-AP MLD accepts the request. In response to the non-AP MLD not accepting the request, the response message carries a rejection reason parameter. In response to the non-AP MLD accepting the request, the response message carries a link identifier of an accepted target link, or does not carry the link identifier of the accepted target link and indicate that the link status transition request is accepted.

For example, the AP MLD initiates a request by using the TID-to-link mapping negotiation request message, and the non-AP MLD responds with the TID-to-link mapping negotiation response message. The TID-to-link mapping negotiation response message indicates whether the non-AP MLD accepts a mapping configuration request between the traffic identifier and the link initiated by the AP MLD. Optionally, the mapping configuration request between the traffic identifier and the link is actually a link switch request. Therefore, the TID-to-link mapping negotiation response message indicates whether the non-AP MLD accepts the link switch request initiated by the AP MLD.

In at least one embodiment, the link switch method is the same as that of the link status transition method that is initiated by the AP MLD and responded by the non-AP MLD in the point 5. An only difference is that in the point 5, the target link is a link whose status is transited, and in at least one embodiment, the target link is a switched-to link. Therefore, for related content in at least one embodiment, “status transition” in the foregoing Table 4 and related content is changed to “switch”, as shown in Table 5. For information that is carried in each request message and each response message and that is described based on Table 5, refer to related content in Table 4. Details are not described herein again.

TABLE 5

| Optional request modes | Optional answer modes |
|---|---|
| of the AP MLD | of the non-AP MLD |
| (1a) Recommend switch, and | (1b) Accept switch of all |
| recommend one or more switched-to | recommended target links. |
| target links. | (2b) Accept switch of one or |
| | more of the recommended target |
| | links. |
| | (3b) Reject switch. |
| (2a) Require switch, switch of | (1b) Accept switch of all |
| one or more target links, and | recommended target links. |
| accept no modification on the | (3b) Reject switch. |
| target link. | |

For the foregoing request modes and answer modes, as described in the third embodiment, the link switch request message, the cross-link info request message, the TID-to-link mapping negotiation request message, the link switch response message, the cross-link info report message, and the TID-to-link mapping negotiation response message carries a newly defined link switch element (link switch element).

As shown in FIG. 8, the link switch element includes a link switch request (link switch request) field and a link switch type (link switch type) field. In each field or frame in at least one embodiment, a field identifier (element ID) indicates a field, and a length (Length) indicates a length of the field. The link switch request field indicates whether a STA that transmits a link of the link switch element is a STA of a link switch request or a STA of a link switch response. The link switch type field indicates one of the foregoing request modes and answer modes. For example, in response to the link switch type field being 0 to 2, a message that carries the link switch element is a link switch request message in the request mode (la) to the request mode (3a). In response to the link switch type field being 3 to 6, a message that carries the link switch element is a link switch response message in the foregoing answer mode (lb) to the answer mode (4b). Further, the non-AP MLD and the AP MLD determine, based on the link switch element, information that needs to be carried in the request and information that needs to be carried in the response.

For the foregoing request modes and answer modes, as described in the fifth embodiment, the TID-to-link mapping negotiation request message and the TID-to-link mapping negotiation response message carries a newly defined link status transition element (link status transition element). A structure of the link status transition element is similar to that shown in FIG. 8, and includes a link status transition request (link status transition request) field and a link status transition type (link status transition type) field. The link status transition request field indicates whether a STA that transmits a link of the link status transition element is a STA of a link status transition request or a STA of a link status transition response. The link status transition type field indicates one of the foregoing request modes and answer modes. For example, In response to the link status transition type field being 0 to 1, a message that carries the link status transition element is one of the foregoing request modes (1a) to request mode (2a). In response to the link status transition type field being 2 to 4, a message that carries the link status transition element is one of the answer modes 1b) to answer mode (3b). Further, the non-AP MLD and the AP MLD determine, based on the link status transition element, information that needs to be carried in the request and information that needs to be carried in the response.

### 7. Another Link Processing Method

A difference between the method and the link processing method described in part 6 lies in that, in this aspect, the second MLD determines whether a BSS configuration of a switched-to second link or the second link whose status is transited is updated. Further, on a first link, an updated parameter is sent to a first MLD, or the first MLD is notified that the BSS configuration of the second link is not updated. In this way, the first MLD directly transmits a data frame on the switched-to second link or the second link whose status is transited, and does not need to transmit the data frame until a beacon frame is further received and a latest parameter of the BSS configuration is obtained on the switched-to second link or the second link whose status is transited. Therefore, the method reduces a waiting time used before the data frame is transmitted on the switched-to second link or the second link whose status is transited.

For ease of description, an example in which the first MLD is a non-AP MLD and the second MLD is an AP MLD is used. In addition, for a first link and a second link included in a plurality of links between the AP MLD and the non-AP MLD, a link 1 and a link 2 is separately used as an example. The link 2 is a switched-to link from the link 1 or a link whose status is transited. That is, the link 1 is in an enable state, and the link 2 is in a doze/disable state, and the link 2 needs to be transited from a doze/disable state to an awake/enable state. A status of a link 3 is not discussed.

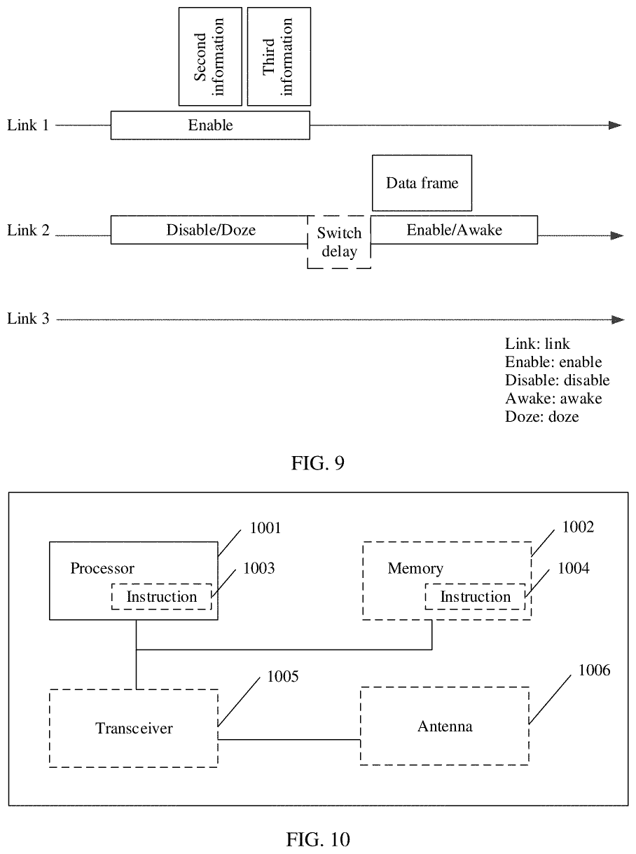

With reference to FIG. 9, the link processing method includes the following steps.

201: The non-AP MLD sends second information of the link 2 on the link 1. The second information is used by the AP MLD to determine whether a BSS configuration of the link 2 is updated.

202: The AP MLD receives the second information of the link 2 on the link 1.

203: The AP MLD sends third information on the link 1. The third information is determined by the AP MLD based on the second information. The third information indicates that the BSS configuration of the link 2 is not updated or an updated parameter of the BSS configuration of the link 2.

204: The non-AP MLD receives the third information on the link 1, and transmits a data frame on the link 2 based on the third information.

The non-AP MLD directly transmits the data frame before receiving a beacon frame on the switched-to link 2 or the link 2 whose status is transited. This reduces a waiting time used before the link 2 transmits the data frame.

In response to the BSS configuration of the link 2 being updated, the third information includes the updated parameter of the BSS configuration of the second link. In response to the BSS configuration of the link 2 not being updated, the third information indicates that the BSS configuration of the second link is not updated.

In response to the BSS configuration of the link 2 being updated, in step 204, that the non-AP MLD transmits a data frame on the link 2 based on the third information includes: The non-AP MLD updates the BSS configuration of the link 2 in the non-AP MLD by using the updated parameter of the BSS configuration of the link 2, and transmits the data frame on the link 2 based on an updated BSS configuration of the link 2. The non-AP MLD further correspondingly updates a sequence number of the BSS configuration/AP-CSN/check beacon value that identifies the link 2. In response to the BSS configuration of the link 2 not being updated, the non-AP MLD transmits the data frame on the link 2 by using the BSS configuration of the link 2 in the non-AP MLD.

The data frame is an uplink data frame or a quality of service null (QoS NULL) frame, to notify the second MLD that the link 2 is in an awake/enable state. Optionally, the first MLD further transmits a link status notification frame on the link 2. The link status notification frame indicates that the link 2 is in the awake/enable state, so that the second MLD sends a downlink data frame on the link 2 in time.

The second information of the link 2 is a sequence number of the BSS configuration, an access point configuration sequence number (AP-CSN), or a check beacon (check beacon) value that is stored in the first MLD and that identifies the link 2. The first information is a sequence number of the BSS configuration, an access point configuration sequence number (AP-CSN), or a check beacon (check beacon) value that is in the second MLD and that identifies the link 2. In this way, the second MLD compares whether the first information is consistent with the second information. In response to the first information being consistent with the second information, the BSS configuration of the link 2 is not updated. In response to the first information being inconsistent with the second information, the BSS configuration of the link 2 is updated. This helps the AP MLD learn, based on the first information and the second information, whether the BSS configuration of the link 2 is updated.

That is, the first information of the link 2 is a sequence number of the current BSS configuration, an AP-CSN, or a check beacon value of the link 2. The second information is a sequence number of the BSS configuration, an AP-CSN, or a check beacon value that is of the link 2 and that is previously obtained by the non-AP MLD. Therefore, in response to the recently updated or current BSS configuration of the link 2 not being updated compared with the BSS configuration of the link 2 that is previously obtained by the non-AP MLD, the first information is equal to the second information. In response to the recently updated or current BSS configuration of the link 2 is updated, the first information is not equal to or greater than the second information.

For example, the first information of the link 2 is an AP-CSN 1, and the second information of the link 2 is an AP-CSN 2. In response to the AP-CSN 1 being equal to the AP-CSN 2, the BSS configuration of the link 2 corresponding to the AP-CSN 1 is not updated compared with the BSS configuration of the link 2 corresponding to the AP-CSN 2. That is, the BSS configuration of the link 2 is not updated. In response to the AP-CSN 1 not being equal to or greater than the AP-CSN 2, the BSS configuration of the link 2 corresponding to the AP-CSN 1 is updated compared with the BSS configuration of the link 2 corresponding to the AP-CSN 2. That is, the BSS configuration of the link 2 is updated. Further, the updated parameter that is updated in the BSS configuration of the link 2 is obtained through the third information.

Optionally, the second information of the link 2 is obtained by the non-AP MLD from a beacon (beacon) frame or a multi-link probe response frame of the link 1 in response to the non-AP MLD performing channel sounding. Alternatively, the second information of the link 2 is obtained by the non-AP MLD from a multi-link probe response frame of the link 1 in response to the non-AP MLD performing link association.

Optionally, the beacon (beacon) frame, the multi-link probe response frame, or a multi-link association response frame of the link 1 carries information about a plurality of links or all links. Information about each link includes the second information, and further includes but is not limited to one or more of the following: a link status, channel utilization, and the like. In at least one embodiment, in response to the non-AP MLD performing link switching or link status transition, the non-AP MLD selects, based on the information, a switched-to link or a link whose status is transited.

For a manner of carrying the second information in the beacon (beacon) frame of the link 1, refer to related descriptions in FIG. 6 in the part 6. For a manner of carrying the second information in the multi-link probe response frame, refer to related descriptions in FIG. 7 in the part 6. For other carried information, refer to the description in the part 6.

In at least one embodiment, the non-AP MLD sends a link switching request message, a cross-link information report request message, or a request frame for negotiating a mapping relationship between a traffic identifier and a link on link 1, to notify the AP MLD of the second information of the link 2. That is, the second information of the link 2 is carried in the link switching request message, the cross-link information report request message, or the request frame for negotiating the mapping relationship between the traffic identifier and the link.

Correspondingly, the non-AP MLD receives a link switching response message, a cross-link information report message, a medium access control frame, or a response frame for negotiating a mapping relationship between a traffic identifier and a link on the link 1, to obtain the third information of the link 2. In at least one embodiment, that the first multi-link device (MLD) receives the third information on the link 1 includes: The non-AP MLD receives, on the link 1, the link switching response message, the cross-link information report message, the medium access control frame, or the response frame for negotiating the mapping relationship between the traffic identifier and the link on. The third information of the link 2 is carried in the link switching response message, the cross-link information report message, the medium access control frame, or the response frame for negotiating the mapping relationship between the traffic identifier and the link.

The request frame for negotiating the mapping relationship between the traffic identifier and the link from the non-AP MLD is sent in response to the non-AP MLD changing the mapping relationship between the link and the traffic identifier, so that link statuses of some links need to be transited from a disable/doze state to an enable/awake state. Correspondingly, the response frame for negotiating the mapping relationship between the traffic identifier and the link returned by the AP MLD indicates whether the AP MLD accepts a mapping configuration request between the traffic identifier and the link. Optionally, in response to the AP MLD accepting the mapping configuration request, the response frame for negotiating the mapping relationship between the traffic identifier and the link includes the third information of the link 2. In response to the AP MLD not accepting the mapping configuration request, the response frame for negotiating the mapping relationship between the traffic identifier and the link does not include the third information of the link 2.

In at least one embodiment, the non-AP MLD actively reports the second information of the switched-to link, to obtain the third information. This helps further shorten a waiting time used before the data frame is transmitted on the switched-to link.

From a perspective of initiation of the non-AP MLD, the following describes other information that is carried by the non-AP in addition to the second information of the link 2, and other information that is carried by the AP MLD in addition to the third information of the link 2.

1. Link Switch Method Initiated by the Non-AP MLD and Responded by the AP MLD

In the link switch method, the non-AP MLD initiates a request by using the link switch request message, the cross-link info request message, or the TID-to-link mapping negotiation request message. The AP MLD responds or answer by using the corresponding link switch response message, the cross-link info report message, or the TID-to-link mapping negotiation response message. Different request modes for link switch determine information carried in these request messages. Correspondingly, different answer modes also determine information carried in these response messages. However, with reference to the foregoing embodiments, these request messages carry at least the second information of the switched-to link, and these response messages carry at least the third information of the switched-to link. Various optional request modes and answer modes greatly improve flexibility of a link switch operation, and facilitate use of a corresponding request mode and answer mode based on a specific scenario.

The link switch response message and the cross-link info report message carry information to indicate whether the AP MLD accepts a link switch request initiated by the non-AP MLD. The TID-to-link mapping negotiation response message indicates whether the AP MLD accepts a mapping configuration request between the traffic identifier and the link initiated by the non-AP MLD. The mapping configuration request between the traffic identifier and the link is actually a link switch request. Therefore, the TID-to-link mapping negotiation response message indicates whether the AP MLD accepts the link switch request initiated by the non-AP MLD.

A difference between the request message and the response message in this part and the point 3 in the part 6 lies in that the request message in this part carries at least the second information of the switched-to link, and the response message in this part carries at least the third information of the switched-to link, and does not need to carry the first information of the switched-to link. For other content, refer to point 3 in part 6. Details are not described herein again.

2. Link Status Transition Method Initiated by the Non-AP MLD and Responded by the AP MLD

In the link status transition method, the non-AP MLD initiates a request by using the link switch request message, the cross-link info request message, or the TID-to-link mapping negotiation request message. The AP MLD responds or answer by using the corresponding link switch response message, the cross-link info report message, or the TID-to-link mapping negotiation response message. This embodiment is the same as that of the link switch method that is initiated by the non-AP MLD and responded by the AP MLD in the point 1. An only difference is that in the point 3, the target link is a switched-to link, and in this embodiment, a target link is a link whose status is transited. Therefore, for related content in this embodiment, “switch” in the point 1 in the part 7 and related content is changed to “status transition”.

Optionally, a difference between the request message and the response message in this part and the point 4 in the part 6 lies in that the request message in this part carries at least the second information of the switched-to link, and the response message in this part carries at least the third information of the switched-to link, and does not need to carry the first information of the switched-to link. For other content, refer to point 4 in part 6. Details are not described herein again.

The foregoing embodiments have their own emphasis. For embodiments not described in detail, refer to another embodiment. Details are not described herein again. Further, embodiments described in this specification is independent solutions, or is combined based on internal logic. These solutions all fall within the protection scope of embodiments described herein. In other words, the foregoing embodiments is combined with each other. For example, the link processing method described in the point 1 in the part 6 is combined with the link processing method described in point 2 in the part 6. For another example, the methods described in the point 1, the point 2, and the point 3 in the part 6 is combined. For another example, the methods described in the point 1, the point 2, and the point 4 in the part 6 is combined. For another example, the methods described in the point 1, the point 2, and the point 5 in the part 6 is combined. For another example, the methods described in the point 1, the point 2, and the point 6 in the part 6 is combined. For another example, the link processing method shown in FIG. 9 in the part 7 is combined with the method described in point 1 in the part 7. For another example, the link processing method shown in FIG. 9 in the part 7 is combined with the method described in point 2 in the part 7.

The foregoing separately describes the link processing methods provided in embodiments described herein from a perspective of interaction between the first MLD and the second MLD, for example, from a perspective of interaction between a non-AP MLD and an AP MLD. Related operations of the non-AP MLD and the AP MLD before and after switch between a link 1 and a link 2 are described above by using the link 1 and the link 2 as an example. In operations related to the non-AP MLD and the AP MLD, operations of the non-AP MLD and the AP MLD on the link 1 is separately performed by a STA 1 corresponding to the link 1 and an AP 1 corresponding to the link 1. Correspondingly, operations of the non-AP MLD and the AP MLD on the link 2 is separately performed by a STA 2 corresponding to the link 2 and an AP 2 corresponding to the link 2.

To implement fast switch between links and fast transition between link statuses, the following plurality of multi-link devices are described in at least one embodiment.

In at least one embodiment, a multi-link device is provided. The multi-link device includes one or more stations. A first station and a second station are used as an example.

The first station receives first information of a second link on a first link. The first information is used by the multi-link device to determine whether a basic service set BSS configuration of the second link is updated.

In response to the BSS configuration of the second link not being updated, the second station transmits a data frame on the switched-to second link or the second link whose link status is transited.

Before the multi-link device switches from the first link to the second link or transits the link status of the second link, the multi-link device learns whether a parameter of the BSS configuration of the second link is updated. In response to the parameter of the BSS configuration of the second link not being updated, after the second link is switched to or the link status of the second link is transited, the second station directly transmits the data frame on the second link without waiting for a beacon frame to be received. This shortens a waiting time used before the data frame is transmitted on the switched-to second link or the second link whose link status is transited.

The multi-link device described in at least one embodiment has any function of the first MLD in the first aspect of the summary and any function of the non-AP MLD in the part 6 of the specific embodiments. For all technical details of the multi-link device, refer to the content in the first aspect of the summary and in the part 6 of the specific implementations. Details are not described herein again.

In at least one embodiment, a multi-link device is provided. The multi-link device includes one or more access points. A first access point and an access point are used as an example.

The first access point determines first information of a second link, and sends the first information of the second link on a first link. The first information is used by a non-AP MLD to determine whether a basic service set BSS configuration of the second link is updated.

Before the multi-link device switches from the first link to the second link or transits a link status of the second link, the first access point notifies a first station of the first information of the second link, so that a second station determines whether a parameter of the BSS configuration of the second link is updated. In response to the parameter of the BSS configuration of the second link not being updated, after the second link is switched to or the link status of the second link is transited, the second station directly transmits a data frame on the second link without waiting for a beacon frame to be received. This helps reduce a waiting time used before the data frame is transmitted on the second link.

The multi-link device described in at least one embodiment has any function of the second MLD in each link processing method in the second aspect of the summary, or has any function of the AP MLD in each link processing method in the part 6. Details are not described herein again.

In at least one embodiment, a multi-link device is provided. The multi-link device includes one or more stations. A first station and a second station are used as an example.

The first station sends second information of a second link on a first link. The second information is used by an AP MLD to determine whether a BSS configuration of the second link is updated.

The first station receives third information of the second link on the first link. The third information is determined by the AP MLD based on the second information. The third information indicates that the BSS configuration of the second link is not updated or an updated parameter of the BSS configuration of the second link.

The second station transmits a data frame on the second link based on the third information.

Before the multi-link device switches from the first link to the second link or transits a link status of the second link, the second station learns of the third information. Therefore, after the second link is switched to, the data frame is directly transmitted on the second link based on the third information without waiting for a beacon frame to be received. This helps reduce a waiting time used before the data frame is transmitted on the second link.

The multi-link device in at least one embodiment has any function of the first MLD in the third aspect of the summary, or any function of the non-AP MLD in part 7 of the specific implementations. Details are not described herein again.

In at least one embodiment, a multi-link device is provided. The multi-link device includes one or more access points. A first access point and a second access point are used as an example. The first access point receives second information of a second link on a first link. The second information is used by an AP MLD to determine whether a BSS configuration of the second link is updated.

The first access point sends third information of the second link on the first link. The third information is determined by the AP MLD based on the second information. The third information indicates that the BSS configuration of the second link is not updated or an updated parameter of the BSS configuration of the second link.

Before the multi-link device switches from the first link to the second link or transits a link status of the second link, the first access point notifies the first station of the third information of the second link. Therefore, after the second link is switched to, the second station directly transmits a data frame on the second link based on the third information without waiting for a beacon frame to be received. This helps reduce a waiting time used before the data frame is transmitted on the second link after the first link is switched to the second link or the link status of the second link is transited.

The multi-link device in at least one embodiment has any function of the second MLD in the fourth aspect of the summary, or any function of the AP MLD in part 7 of the specific implementations. Details are not described herein again.

To implement the functions in the foregoing method provided in embodiments described herein, the access point and the station includes a hardware structure and a software module, to implement the foregoing functions in a form of the hardware structure, the software module, or a combination of the hardware structure and the software module. A function in the foregoing functions is performed in a form of the hardware structure, the software module, or a combination of the hardware structure and the software module. The multi-link device described below is an AP MLD, or is a non-AP MLD, or is a chip, a chip system, or a processor that supports the multi-link device in implementing the foregoing method, or is a chip, a chip system, or a processor that supports the multi-link device in implementing the foregoing method. The multi-link device is configured to implement the method described in the foregoing method embodiments. For details, refer to the descriptions in the foregoing method embodiments.

FIG. 10 is a schematic diagram of a structure of a multi-link device according to at least one embodiment. The multi-link device includes one or more processors 1001. The processor 1001 is a general-purpose processor, a dedicated processor, or the like. The processor 1001 is configured to: control one or more access points, one or more access point chips, one or more stations, one or more station chips, and the like in the multi-link device, execute a software program, and process data of the software program.

Optionally, the multi-link device includes one or more memories 1002. The memory 1002 stores an instruction 1004. The instruction is run on the processor 1001, so that the multi-link device performs the method described in the foregoing method embodiments. Optionally, the memory 1002 further stores data, for example, store the first information, the second information, or the third information in the foregoing method embodiment. The processor 1001 and the memory 1002 is separately disposed, or is integrated together.

Optionally, the multi-link device further includes a transceiver 1005 and an antenna 1006. The transceiver 1005 is referred to as a transceiver unit, a transceiver machine, a transceiver circuit, or the like, and is configured to implement a transceiver function. The transceiver 1005 includes a receiver and a transmitter. The receiver is referred to as a receiving machine, a receiver circuit, or the like, and is configured to implement a receiving function. The transmitter is referred to as a transmitting machine, a transmitter circuit, or the like, and is configured to implement a sending function. The transceiver 1005 is configured to perform the receiving or sending operation in the foregoing method embodiments.

In at least one embodiment,

the transceiver 1005 is configured to receive first information of a second link on a first link.

A plurality of links between a first MLD and a second MLD include the first link and the second link.

The first information is used by the first MLD to determine whether a basic service set BSS configuration of the second link is updated.

The transceiver 1005 is further configured to: in response to the BSS configuration of the second link not being updated, transmit a data frame on the switched-to second link or the second link whose link status is transited.

The multi-link device learns whether a parameter of the BSS configuration of the second link is updated. In response to the parameter of the BSS configuration of the second link not being updated, the multi-link device directly transmits the data frame on the switched-to second link or the second link whose link status is transited. This shortens a waiting time used before the data frame is transmitted on the switched-to second link or the second link whose link status is transited.

The multi-link device described in at least one embodiment has any function of the first MLD in the first aspect of the summary and any function of the non-AP MLD in the part 6 of the specific embodiment. For all technical details of the multi-link device, refer to the content in the first aspect of the summary and in the part 6 of the specific embodiment. Details are not described herein again.

In at least one embodiment,

the processor 1001 is configured to determine first information of a second link. The first information is used by a first MLD to determine whether a basic service set BSS configuration of the second link is updated.

The transceiver 1005 is configured to send the first information of the second link on a first link.

A plurality of links between a second MLD and the first MLD include the first link and the second link.

The second link is a link that is switched from the first link or a link whose link status is transited.

At least one embodiment helps the first MLD to determine whether a parameter of the BSS configuration of the second link is updated. In response to the parameter of the BSS configuration of the second link not being updated, the first MLD directly transmits a data frame on the switched-to second link or the second link whose link status is transited. This shortens a waiting time used before the data frame is transmitted on the switched-to second link or the second link whose link status is transited.

The multi-link device described in at least one embodiment has any function of the second MLD in each link processing method in the second aspect of the summary, or has any function of the AP MLD in each link processing method in the part 6. Details are not described herein again.

In at least one embodiment,

the transceiver 1005 is configured to send second information of a second link on a first link. The second information is used by an second MLD to determine whether a BSS configuration of the second link is updated.

The transceiver 1005 is configured to receive third information on the first link. The third information is determined by the second MLD based on the second information. The third information indicates that a BSS configuration of the second link is not updated or indicates an updated parameter of the BSS configuration of the second link. In this way, a first MLD can transmit a data frame on the second link based on the third information.

The multi-link device directly transmits the data frame on the switched-to second link or the second link whose status is transited. This reduces a waiting time used before the data frame is transmitted on the switched-to second link or the second link whose status is transited.

In at least one embodiment,

the transceiver 1005 is configured to receive second information of a second link on a first link. The second information is used by the multi-link device to determine whether a BSS configuration of the second link is updated.

The transceiver 1005 is configured to send third information on the first link. The third information is determined by the multi-link device based on the second information. The third information indicates that the BSS configuration of the second link is not updated or an updated parameter of the BSS configuration of the second link.

Because the multi-link device notifies the non-AP MLD on the first link whether the BSS configuration of the second link is updated or the updated parameter of the BSS configuration of the second link, the non-AP MLD directly transmits a data frame on the switched-to second link or the second link whose status is transited without waiting for a beacon frame to be received. This reduces a waiting time used before the data frame is transmitted on the switched-to second link or the second link whose status is transited.

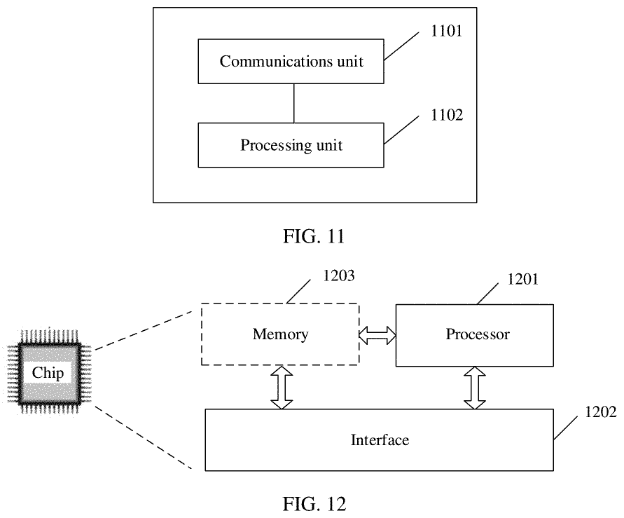

FIG. 11 is a schematic diagram of a structure of another multi-link device according to an embodiment described herein. The multi-link device includes a communications unit 1101 and a processing unit 1102. The communications unit 1101 includes a sending unit and a receiving unit. The sending unit is configured to implement a sending function, the receiving unit is configured to implement a receiving function, and the communications unit 1101 implements a sending function and/or a receiving function. The communications unit may also be described as a transceiver unit.

In at least one embodiment,

the communications unit 1101 is configured to receive first information of a second link on a first link.

A plurality of links between a first MLD and a second MLD include the first link and the second link.

The first information is used by the first MLD to determine whether a basic service set BSS configuration of the second link is updated.

The communications unit 1101 is further configured to: in response to the BSS configuration of the second link not being updated, transmit a data frame on the switched-to second link or the second link whose link status is transited.

The multi-link device learns whether a parameter of the BSS configuration of the second link is updated. In response to the parameter of the BSS configuration of the second link is not updated, the multi-link device directly transmits the data frame on the switched-to second link or the second link whose link status is transited. This shortens a waiting time used before the data frame is transmitted on the switched-to second link or the second link whose link status is transited.

The multi-link device described in at least one embodiment has any function of the first MLD in the first aspect of the summary and any function of the non-AP MLD in the part 6 of the specific embodiments. For all technical details of the multi-link device, refer to the content in the first aspect of the summary and in the part 6 of the specific embodiments. Details are not described herein again.

In at least one embodiment,

the processing unit 1102 is configured to determine first information of a second link. The first information is used by a first MLD to determine whether a basic service set BSS configuration of the second link is updated.

The communications unit 1101 is configured to send the first information of the second link on a first link.

A plurality of links between a second MLD and the first MLD include the first link and the second link.

The second link is a link that is switched from the first link or a link whose link status is transited.

At least one embodiment helps the first MLD to determine whether a parameter of the BSS configuration of the second link is updated. In response to the parameter of the BSS configuration of the second link not being updated, the first MLD directly transmits a data frame on the switched-to second link or the second link whose link status is transited. This shortens a waiting time used before the data frame is transmitted on the switched-to second link or the second link whose link status is transited.

The multi-link device described in at least one embodiment has any function of the second MLD in each link processing method in the second aspect of the summary, or has any function of the AP MLD in each link processing method in the part 6. Details are not described herein again.

In at least one embodiment,

the communications unit 1101 is configured to send second information of a second link on a first link. The second information is used by an second MLD to determine whether a BSS configuration of the second link is updated.

The communications unit 1101 is configured to receive third information on the first link. The third information is determined by the second MLD based on the second information. The third information indicates that a BSS configuration of the second link is not updated or indicates an updated parameter of the BSS configuration of the second link. In this way, a first MLD transmits a data frame on the second link based on the third information.

The multi-link device directly transmits the data frame on the switched-to second link or the second link whose status is transited. This reduces a waiting time used before the data frame is transmitted on the switched-to second link or the second link whose status is transited.

In at least one embodiment,

the communications unit 1101 is configured to receive second information of a second link on a first link. The second information is used by the multi-link device to determine whether a BSS configuration of the second link is updated.

The communications unit 1101 is configured to send third information on the first link. The third information is determined by the multi-link device based on the second information. The third information indicates that the BSS configuration of the second link is not updated or an updated parameter of the BSS configuration of the second link.

Because the multi-link device notifies the non-AP MLD on the first link whether the BSS configuration of the second link is updated or the updated parameter of the BSS configuration of the second link, the non-AP MLD directly transmits a data frame on the switched-to second link or the second link whose status is transited without waiting for a beacon frame to be received. This reduces a waiting time used before the data frame is transmitted on the switched-to second link or the second link whose status is transited.

For specific embodiments of each functional unit included in the multi-link device, refer to the foregoing embodiments. Details are not described herein again.

FIG. 12 is a schematic diagram of a structure of a chip according to at least one embodiment. As shown in FIG. 12, the chip shown in FIG. 12 includes a processor 1201 and an interface 1202. There is one or more processors 1201. There is a plurality of interfaces 1202.

For a case in which the chip is configured to implement functions of the station in at least one embodiment:

in an embodiment,

the transceiver 1202 is configured to receive first information of a second link on a first link.

A plurality of links between a first MLD and a second MLD include the first link and the second link.

The first information is used by the first MLD to determine whether a basic service set BSS configuration of the second link is updated.

the interface 1202 is further configured to: in response to the BSS configuration of the second link is not updated, transmit a data frame on the switched-to second link or the second link whose link status is transited.

The multi-link device may learn whether a parameter of the BSS configuration of the second link is updated. In response to the parameter of the BSS configuration of the second link not being updated, the multi-link device directly transmits the data frame on the switched-to second link or the second link whose link status is transited. This shortens a waiting time used before the data frame is transmitted on the switched-to second link or the second link whose link status is transited.

The multi-link device described in at least one embodiment has any function of the first MLD in the first aspect of the summary and any function of the non-AP MLD in the part 6 of the specific embodiments. For all technical details of the multi-link device, refer to the content in the first aspect of the summary and in the part 6 of the specific embodiments. Details are not described herein again.

In at least one embodiment,

the processor 1201 is configured to determine first information of a second link. The first information is used by a first MLD to determine whether a basic service set BSS configuration of the second link is updated.

The interface 1202 is configured to send the first information of the second link on a first link.

A plurality of links between a second MLD and the first MLD include the first link and the second link.

The second link is a link that is switched from the first link or a link whose link status is transited.

At least one embodiment helps the first MLD to determine whether a parameter of the BSS configuration of the second link is updated. In response to the parameter of the BSS configuration of the second link not being updated, the first MLD directly transmits a data frame on the switched-to second link or the second link whose link status is transited. This shortens a waiting time used before the data frame is transmitted on the switched-to second link or the second link whose link status is transited.

The multi-link device described in at least one embodiment has any function of the second MLD in each link processing method in the second aspect of the summary, or has any function of the AP MLD in each link processing method in the part 6. Details are not described herein again.

In at least one embodiment,

the interface 1202 is configured to send second information of a second link on a first link. The second information is used by an second MLD to determine whether a BSS configuration of the second link is updated.

The interface 1202 is configured to receive third information on the first link. The third information is determined by the second MLD based on the second information. The third information indicates that the BSS configuration of the second link is not updated or an updated parameter of the BSS configuration of the second link. In this way, a first MLD transmits a data frame on the second link based on the third information.

The multi-link device directly transmits the data frame on the switched-to second link or the second link whose status is transited. This reduces a waiting time used before the data frame is transmitted on the switched-to second link or the second link whose status is transited.

In at least one embodiment,

the interface 1202 is configured to receive second information of a second link on a first link. The second information is used by the multi-link device to determine whether a BSS configuration of the second link is updated.

The interface 1202 is configured to send third information on the first link. The third information is determined by the multi-link device based on the second information. The third information indicates that the BSS configuration of the second link is not updated or an updated parameter of the BSS configuration of the second link.

Because the multi-link device notifies the non-AP MLD on the first link whether the BSS configuration of the second link is updated or the updated parameter of the BSS configuration of the second link, the non-AP MLD directly transmits a data frame on the switched-to second link or the second link whose status is transited without waiting for a beacon frame to be received. This reduces a waiting time used before the data frame is transmitted on the switched-to second link or the second link whose status is transited.

The term “and/or” in this specification describes only an association relationship for describing associated objects and represents that three relationships exist. For example, A and/or B represents the following three cases: Only A exists, both A and B exist, and only B exists. In addition, the character “I” in this specification generally indicates an “or” relationship between the associated objects.

A person of ordinary skill in the art is aware that, in combination with the examples described in the embodiments disclosed in this specification, method steps and units is implemented by electronic hardware, computer software, or a combination thereof. To clearly describe interchangeability between the hardware and the software, the foregoing has generally described steps and compositions of each embodiment according to functions. Whether the functions are performed by using hardware or software depends on particular applications and design constraints of the technical solutions. A person of ordinary skill in the art is able to use different methods to implement the described functions for each particular application, but the implementation goes beyond the scope of embodiments described herein.

A person skilled in the art understands that, for the purpose of convenient and brief description, for a detailed working process of the foregoing described system, apparatus, and unit, reference is made to a corresponding process in the foregoing method embodiments. Details are not described herein again.

In the several embodiments described herein, the disclosed system, apparatus, and method is implemented in other manners. For example, the foregoing apparatus embodiments are merely examples. For example, division into the units is merely logical function division and is other division in actual implementation. For example, a plurality of units or components is combined or integrated into another system, or some features is ignored or not performed. In addition, the displayed or discussed mutual couplings or direct couplings or communication connections is implemented through some interfaces. The indirect couplings or communication connections between the apparatuses or units is implemented in electrical, mechanical, or other forms.

The units described as separate parts may or may not be physically separate, and parts displayed as units may or may not be physical units, that is, is located in one position, or is distributed on a plurality of network units. A part or all of the units is selected to achieve the objectives of the solutions of embodiments described herein.

In addition, functional units in embodiments described herein is integrated into one processing unit, or each of the units exist alone physically, or two or more units are integrated into one unit. The integrated unit is implemented in a form of hardware, or is implemented in a form of a software functional unit.

In response to the integrated unit being implemented in a form of a software functional unit and sold or used as an independent product, the integrated unit is stored in a computer-readable storage medium. Based on such an understanding, the technical solutions in embodiments described herein essentially, or the part contributing to the conventional art, or all or a part of the technical solutions is implemented in the form of a software product. The computer software product is stored in a storage medium and includes several instructions for instructing a computer device (which is a personal computer, a server, a network device, or the like) to perform all or a part of the steps of the methods described in embodiments described herein. The foregoing storage medium includes any medium that stores program code, such as a USB flash drive, a removable hard disk, a read-only memory (read-only memory, ROM), a random access memory (random access memory, RAM), a magnetic disk, or an optical disc.

The foregoing descriptions are merely specific embodiments described herein, but are not intended to limit the protection scope of embodiment described herein. Any modification or replacement readily figured out by a person skilled in the art within the technical scope fall within the protection scope of embodiments described herein. Therefore, the protection scope of embodiments described herein are be subject to the protection scope of the claims.

1. A link processing method, wherein the method comprises:
receiving, by a first multi-link device (MLD), first information of a second link on a first link, wherein
a plurality of links between the first MLD and a second MLD include the first link and the second link; and
using, by the first MLD, the first information to determine whether a basic service set (BSS) configuration of the second link is updated; and
in response to the BSS configuration of the second link not being updated, transmitting, by the first MLD, a data frame on the switched-to second link or the second link whose link status is transited.

2. The method according to claim 1, wherein the transmitting the data frame by the first MLD includes transmitting an uplink data frame, a quality of service null (QoS NULL) frame, or a link status notification frame, wherein the link status notification frame indicates that the second link is in an awake or enable state.

3. The method according to claim 1, wherein
the receiving, by the first multi-link device (MLD), the first information of the second link includes receiving a sequence number of the BSS configuration, or an access point configuration sequence number (AP-CSN), or a check beacon (check beacon) value that is in the second MLD and that identifies the second link.

4. The method according to claim 1, wherein
the receiving, by the first multi-link device (MLD), the first information of the second link comprising carrying in a link switching response message, or a cross-link information report message, or a medium access control frame, or a response frame for negotiating a mapping relationship between a traffic identifier and a link, or a beacon frame, or a control field of the data frame, or a request frame for negotiating the mapping relationship between the traffic identifier and a link that is received on the first link.

5. The method according to claim 4, wherein in response to the first information of the second link being carried in the request frame for negotiating the mapping relationship between the traffic identifier and the link that is received on the first link, before the transmitting, by the first MLD, the data frame on the second link, the method further comprises:
sending, by the first MLD, the response frame for negotiating the mapping relationship between the traffic identifier and the link on the first link, wherein
the response frame for negotiating the mapping relationship between the traffic identifier and the link indicates whether the first MLD accepts the mapping configuration request between the traffic identifier and the link.

6. A link processing method, wherein the method comprises:
determining, by a second multi-link device (MLD), first information of a second link, wherein the first information is used by a first MLD to determine whether a basic service set (BSS) configuration of the second link is updated; and
sending, by the second MLD, the first information of the second link on a first link, wherein
a plurality of links between the second MLD and the first MLD include the first link and the second link, and
wherein the second link is a link that is switched from the first link or a link whose link status is transited.

7. The method according to claim 6, wherein the method further comprises:
receiving, by the second MLD, a data frame on the second link, wherein the data frame includes an uplink data frame, a quality of service null (QoS NULL) frame, or a link status notification frame, and the link status notification frame indicates that the second link is in an awake or enable state.

8. The method according to claim 6, wherein
The determining, by the second MLD, the first information of the second link includes determining the first information of the second link is a sequence number of the BSS configuration, or an access point configuration sequence number (AP-CSN), or a check beacon (check beacon) value that is in the second MLD and that identifies the second link.

9. The method according to claim 6, wherein
the determining, by the second MLD, the first information of the second link includes determining the first information of the second link is carried, for sending, in a link switching response message, or a cross-link information report message, or a medium access control frame, or a response frame for negotiating a mapping relationship between a traffic identifier and a link, or a beacon frame, or a control field of a data frame, or a request frame for negotiating the a mapping relationship between the traffic identifier and a link that is on the first link.

10. The method according to claim 9, wherein in response to the first information of the second link being carried, for sending, in the request frame for negotiating the mapping relationship between the traffic identifier and the link that being received on the first link, before transmitting, by the second MLD, the data frame on the second link, the method further comprises:
receiving, by the second MLD, the response frame for negotiating the mapping relationship between the traffic identifier and the link on the first link, wherein
the response frame for negotiating the mapping relationship between the traffic identifier and the link indicates whether the first MLD accepts a mapping configuration request between the traffic identifier and the link.

11. A communication apparatus for a first multi-link device (MLD), comprising: at least one processor, and a memory storing instructions for execution by the at least one processor;
wherein, when executed, the instructions cause the processor to perform operations including:
receiving, first information of a second link on a first link, wherein
a plurality of links between the apparatus and a second MLD include the first link and the second link; and
use, by the processor, the first information is used by the apparatus to determine whether a basic service set (BSS) configuration of the second link is updated; and
in response to the BSS configuration of the second link not being updated, transmitting, a data frame on the switched-to second link or the second link whose link status is transited.

12. The communication apparatus according to claim 11, wherein the processor is further configured to transmit the data frame by transmitting an uplink data frame, a quality of service null (QoS NULL) frame, or a link status notification frame, wherein the link status notification frame indicates that the second link is in an awake or enable state.

13. The communication apparatus according to claim 11, wherein
the first information of the second link is a sequence number of the BSS configuration, or an access point configuration sequence number (AP-CSN), or a check beacon (check beacon) value that is in the second MLD and that identifies the second link.

14. The communication apparatus according to claim 11, wherein
the first information of the second link is carried in a link switching response message, or a cross-link information report message, or a medium access control frame, or a response frame for negotiating a mapping relationship between a traffic identifier and a link, or a beacon frame, or a control field of the data frame, or a request frame for negotiating a mapping relationship between the traffic identifier and a link that is received on the first link.

15. The communication apparatus according to claim 14, wherein if the first information of the second link is carried in the request frame for negotiating the mapping relationship between the traffic identifier and the link that is received on the first link, before the transmitting, the data frame on the second link, the processor further configured to:
send, the response frame for negotiating the mapping relationship between the traffic identifier and the link on the first link, wherein
the response frame for negotiating the mapping relationship between the traffic identifier and the link indicates whether the apparatus accepts a mapping configuration request between the traffic identifier and the link.

16. A communication apparatus for a second multi-link device (MLD), comprising: at least one processor, and a memory storing instructions for execution by the at least one processor;
wherein, when executed, the instructions cause the processor to perform operations including:
determining, first information of a second link, wherein the first information is used by a first MLD to determine whether a basic service set (BSS) configuration of the second link is updated;
sending, the first information of the second link on a first link, wherein
a plurality of links between the apparatus and the first MLD include the first link and the second link; and
the second link is a link that is switched from the first link or a link whose link status is transited.

17. The communication apparatus according to claim 16, wherein the processor is further configured to:
receive, a data frame on the second link, wherein the data frame includes an uplink data frame, a quality of service null (QoS NULL) frame, or a link status notification frame, and the link status notification frame indicates that the second link is in an awake or enable state.

18. The communication apparatus according to claim 16, wherein
the first information of the second link is a sequence number of the BSS configuration, or an access point configuration sequence number (AP-CSN), or a check beacon (check beacon) value that is in the apparatus and that identifies the second link.

19. The communication apparatus according to claim 16, wherein the processor is further configured to:
carry the first information of the second link, for sending, in a link switching response message, or a cross-link information report message, or a medium access control frame, or a response frame for negotiating a mapping relationship between a traffic identifier and a link, or a beacon frame, or a control field of a data frame, or a request frame for negotiating a mapping relationship between the traffic identifier and a link that is on the first link.

20. The communication apparatus according to claim 19, wherein in response to the first information of the second link being carried, for sending, in the request frame for negotiating the mapping relationship between the traffic identifier and the link that is being received on the first link, before transmitting, the data frame on the second link, the processor is further configured to
receive, the response frame for negotiating the mapping relationship between the traffic identifier and the link on the first link, wherein
the response frame for negotiating the mapping relationship between the traffic identifier and the link indicates whether the first MLD accepts a mapping configuration request between the traffic identifier and the link.
